(19) United States
(12) Patent Application Publication
(10) Pub. No.: US 2025/0062109 A1
(43) Pub. Date: Feb. 20, 2025

(54) SURFACE-MODIFIED ELECTROSPRAY NEEDLE FOR USE IN MASS SPECTROMETRY

(71) Applicant: Arizona Board of Regents on Behalf of The University of Arizona, Tucson, AZ (US)

(72) Inventors: Michael T. Marty, Tucson, AZ (US); Craig A. Aspinwall, Tucson, AZ (US); Marius M. Kostelic, Tucson, AZ (US)

(21) Appl. No.: 18/720,500

(22) PCT Filed: Dec. 14, 2022
(86) PCT No.: PCT/US2022/081556

§ 371 Date: Jun. 14, 2024

Related U.S. Application Data
(60) Provisional application No. 63/289,477, filed on Dec. 14, 2021.

(51) Int. Cl. H01J 49/16; C03C 17/00; C03C 17/06; C03C 17/30; G01N 30/72

(52) U.S. Cl. CPC H01J 49/167; C03C 17/004; C03C 17/005; C03C 17/06; C03C 17/30; G01N 30/7266; C03C 2217/75

(57) ABSTRACT

An electrospray needle comprising a coating inside the needle, wherein the coating is a non-conductive and non-ionizable organic material, and in some embodiments comprising a conductive outer coating; methods of making the electrospray needle, systems that use the electrospray needle, methods of detection using the electrospray needle, and a kit that includes the electrospray needle.

### CROSS REFERENCE TO RELATED APPLICATIONS

This application claims priority to U.S. application Ser. No. 63/289,477, filed on Dec. 14, 2021, the contents of which are hereby incorporated by reference in its entirety.

### STATEMENT OF FEDERALLY SPONSORED RESEARCH AND DEVELOPMENT

This invention was made with government support under Grant No. CHE-1845230 awarded by the National Science Foundation, and under Grant No. CBET-2003297 awarded by the National Science Foundation. The government has certain rights in the invention.

### FIELD OF THE INVENTION

The field of the invention relates generally to electrospray mass spectrometry, and more particularly to electrospray needles for use in mass spectrometry.

### BACKGROUND OF THE INVENTION

Electrospray ionization (ESI) mass spectrometry (MS) is a vital technique used for characterizing heterogenous protein samples and macromolecular complexes. However, analytes can stick to the walls of electrospray needles, thereby lowering detection sensitivity and disrupting electrospray stability. Additionally, the cleaning of electrospray needles can be problematic or impractical. Given the importance of ESI/MS in the analysis of biomaterials and other materials that can clog electrospray needles, there is a need for improved electrospray needles.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a side cross-sectional view of a non-limiting exemplary embodiment electrospray needle (100) according to the invention. FIGS. 1B and IC are end-on cross-sectional views of a fluid inlet and an outlet orifice of a non-limiting exemplary embodiment of an electrospray needle according to the invention. FIG. 1D shows an exploded view of a non-limiting exemplary embodiment of an electrospray needle according to the invention, showing an organic material covalently bonded to a surface of an interior passage.

FIGS. 2A-2D are graphs showing raw mass spectra of BSA for (FIG. 2A) uncoated control needles and (FIG. 2B) PEG coated needles, and histogram plots showing signal intensity for the most abundant charge state for (FIG. 2C) lysozyme and (FIG. 2D) BSA with the PEG coated and control nESI needles.

FIGS. 3A-3C are graphs showing CD-MS analysis of AAV2 capsids for (FIG. 3A) uncoated control needles and (FIG. 3B) PEG coated needles, and a histogram plot showing total number of single ions collected from a 5-minute CD-MS acquisition for empty AAV2 capsids (FIG. 3C).

FIG. 4 is a histogram plot analysis of AAV2 capsids showing total single ions vs. needle type (PEG coated and control).

FIGS. 5A and 5B are images of manually clipped borosilicate needles and 2 micrometer needles under magnification.

FIG. 6 is a histogram plot signal intensity for BSA using clipped vs. 2 micrometer needles.

FIG. 7 is a histogram plot showing signal intensity of most abundant charge state of BSA with PEG-coated and uncoated control nESI needles with 2 micrometer and 0.1 micrometer tip diameters.

FIGS. 8A and 8B are histogram plots showing analyses of lysozyme and BSA using PFDCS coated needles.

FIG. 9 is a histogram plot showing a comparison of signal intensity for ubiquitin using 2 micrometer control and PEG-coated needles.

FIGS. 10A is an image of the capillary action of control, PEG-modified, and PFDCS-modified nESI needles, and FIG. 10B is a histogram plot showing flow rate of PFDCS-modified, PEG-modified, and unmodified (gray) needles.

FIGS. 11A and 11B are graphs showing deconvolved mass spectra of ubiquitin collected with control (top) and PEG coated (bottom) 2 micrometer needles.

FIG. 12 is a histogram plot showing a signal to noise ratio in the detection of a biomolecule using a mass spectrometry system according to the present invention.

In some embodiments, the figures presented in this patent application may be drawn to scale, including the angles, ratios of dimensions, etc. In some other embodiments, the figures are representative only and the claims are not limited by the dimensions of the figures.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purposes of interpreting this specification, the following definitions will apply and whenever appropriate, terms used in the singular will also include the plural and vice versa. If any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10 % variation from the nominal value. It is to be understood that such a variation is always included in any given value provided herein, whether or not it is specifically referred to.

As used herein, the term “substantially” is a broad term and is used in its ordinary sense, including, without limitation, being largely but not necessarily wholly that which is specified.

The term “alkyl” as used herein by itself or as part of another group refers to both straight and branched chain radicals. In one embodiment, the alkyl group has 1-12 carbons. In another embodiment, the alkyl group has 1-7 carbons. In another embodiment, the alkyl group has 1-6 carbons. In another embodiment, the alkyl group has 1-4 carbons (also referred to as “C₁₋₄ alkyl” or “C1-4 alkyl”). The term “alkyl” may include methyl, ethyl, propyl, isopropyl, butyl, t-butyl, isobutyl, pentyl, hexyl, isohexyl, heptyl, 4,4-dimethylpentyl, octyl, 2,2,4-trimethylpentyl, nonyl, decyl, undecyl, and dodecyl.

The term “alkylene” as used herein refers to straight and branched chain alkyl linking groups, i.e., an alkyl group that links one group to another group in a molecule. In some embodiments, the term “alkylene” may include —(CH₂)ₙ— where n is 2-8.

As used herein, the term “biomolecule” refers to a chemical compound found in living organisms. These include chemicals that are composed of mainly carbon, hydrogen, oxygen, nitrogen, sulfur and phosphorus.

As used herein, the terms “electrically conductive” and “electrical conductivity” refer to an ability to transport an electric current, while the terms “electrically non-conductive” and “electrical non-conductivity” refer to a lack of ability to transport an electric current. Electrically non-conductive materials typically correspond to those materials within which an electric current has little or no tendency to flow. One measure of electrical non-conductivity of a material is its resistivity expressed in ohm meter (“(Ω·m”) (see e.g., ASTM D1125-14). Herein, the material is considered to be electrically non-conductive if its resistivity is greater than 10⁶ Ω·m. The resistivity of a material may vary with temperature. Thus, unless otherwise specified, the resistivity of a material is defined at room temperature.

As used herein, the term “non-ionizable” means substantially incapable (including incapable) of spontaneously acting as a Bronsted acid or base, or dissociating into ionic species, in water (e.g., at standard temperature and pressure).

As used herein, the term “organic chemical” refer to a class of chemicals containing carbon and hydrogen and may comprise other atoms, for example but not limited to nitrogen, oxygen, sulfur, silicon, and halogen (for example, fluorine, chlorine, bromine, and iodine). In some embodiments, “organic chemical” includes fluorocarbons and perfluorocarbons. The organic chemicals used in the present invention may comprise substituents on the carbon-based (organic chemical) framework. For example, the organic chemical can be an alkyl hydrocarbon of 1 to about 20 carbon atoms which can be a substantially linear chain of carbon atoms, which may also be branched, or the said alkyl hydrocarbon may be cyclic such as cyclopropane, cyclopentane or cyclohexane. The functional group can also include, for example, silicon for covalently bonding the organic chemical to a surface. The surface can be, for example, a glass having silanol moieties which can be covalently-bonded to the organic chemical's silicon moiety. The organic chemical can be formed, for example, by treating a glass having silanol moieties with a silylation reagent such as octyldimethylchlorosilane (ODCS), which can react with a silanol moiety on the surface of the glass under suitable reaction conditions known to an individual skilled in the art. There is a large but limited number of small organic chemicals (e.g., having a molecular weight less than about 50 kDa) wherein the organic chemical has a functional group that can form a covalent bond with, for example, a glass surface, while the remaining moiety of the organic chemical is non-ionizable.

As used herein, the term “contact angle” refers to a measure of the wettability of a surface or material. In one aspect, the contact angle is the angle formed between the surface and a liquid droplet. For example, when water is used as the liquid, the smaller the contact angle (e.g., <<90°), the more hydrophilic the surface: and conversely, the larger the contact angle (e.g., >>90°), the more hydrophobic the surface (K. Y. Law, J. Phys. Chem. Lett. 2014, 5, 686-688 “Definitions for Hydrophilicity, Hydrophobicity, and Superhydrophobicity”).

As used herein, the term “amphiphobic” refers to materials that repel both water and oil, for example, a perfluorocarbon. An amphiphobic material can be defined in terms of water and oil contact angles, and as used herein an amphiphobic organic material has a water contact angle in a range of from about 90° to about 175° at 25° C., and an oil contact angle in a range of from about 70° to about 175° at 25° C. (See e.g., U.S. Pat. No. 20,120,264884 at paragraph [0039]).

As used herein, the term “hydrophobic” refers to materials that repel water. Hydrophobic materials can be characterized by the contact angle of a droplet of water on a surface of the material. Contact angles greater than 90° indicate a hydrophobic material; whereas contact angles less than 90° indicate a “hydrophilic” material.

As used herein, the term “oleophobic” refers to materials that repel oil. Oleophobic materials can be characterized by the contact angle of a droplet of a short-chain alkane on a surface of the material. With n-hexadecane, a standard short-chain alkane testing fluid, contact angles between 60° and 80° (and higher) indicate an oleophobic material.

As used herein, the term “hydraulic diameter” (“D_{H}”) refers to four times the cross-sectional area of a tube or channel through which a liquid can flow, divided by the wetted perimeter, the wetted perimeter being the perimeter of the cross-sectional area that is wet. The term “hydraulic diameter” is particularly useful when perimeter of the cross-sectional area is other than circular (including, for example, a rectangular or trapezoidal perimeter). When the cross-sectional area is circular, as in a right circular cylinder, the term “diameter” has its common definition as any straight line-segment that passes through the center of the circle and whose endpoints lie on the circle, and the hydraulic diameter D_{H}= (4 πr²/2 πr)=2r, which is the diameter of the circle.

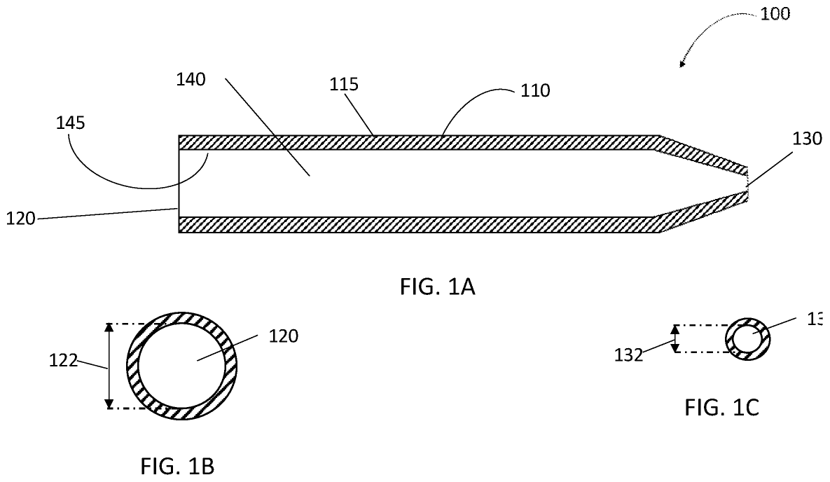

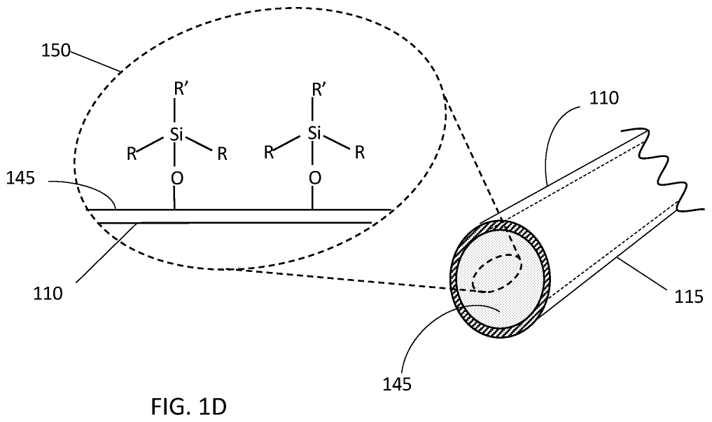

The following is a list of elements according to a particular embodiment referred to herein (see FIGS. 1A-1D):
100 electrospray needle
110 hollow needle body
115 exterior (i.e., outer) surface of hollow needle body (110)
120 fluid inlet
122 inside diameter of fluid inlet (120)
130 outlet orifice
132 inner diameter of outlet orifice (130)
140 interior passage
145 surface of interior passage (140)
150 organic material covalently bonded to surface (145) of interior passage (140).

Mass spectrometry is a technique that is useful to detect the presence of a particular substance or chemical, usually within another substance. Mass spectrometry has a variety of uses, including the development of pharmaceuticals, detection of drugs and drug-protein complexes, detection of proteins, viruses, or endogenous biochemical or biomarkers in blood.

In order for a mass spectrometer to work, a sample needs to be ionized and delivered to the detector in the mass spectrometer. One useful way to do so is through nano-electrospray ionization, which makes use of a tiny needle. However, nano-electrospray needles are known to have challenges with durability and consistency of results. One main cause of the consistency challenge is that the substance being analyzed, instead of spraying effectively through the hole in the needle, get stuck to its interior walls, which can lead to clogging of the needle and related sources of variability.

Advantages of the present invention include, for example, providing an electrospray needle that is less prone to clogging and that has increased mass detection sensitivity and consistency of mass spectrometric analyses.

Referring now to FIGS. 1A-ID, and in particular the lateral cross-sectional view shown in FIG. 1A, in one aspect the present invention features an electrospray emitter (100) comprising a hollow needle body (110) comprising an exterior surface (115), a fluid inlet (120), an outlet orifice (130) and an interior passage (140) linking the fluid inlet (120) and the outlet orifice (130) in fluid communication, said interior passage (140) having a surface (145) comprising a non-limiting embodiment of a covalently bonded organic material (150 in FIG. 1D). In the non-limiting embodiment shown in FIG. 1D, the organic material is a silane, but in other embodiments the covalently-bonded organic material can be selected from among other organic materials, as described herein.

In some embodiments, hollow needle body (110) has an overall length in a range of from about 10 mm to about 100 mm, from about 10 mm to about 90 mm, from about 10 mm to about 80 mm, from about 10 mm to about 70 mm, from about 10 mm to about 60 mm, from about 10 mm to about 50 mm, from about 10 mm to about 40 mm, from about 10 mm to about 30 mm, from about 10 mm to about 20 mm, from about 10 mm to about 15 mm, or even about 10 mm.

In some exemplary embodiments of electrospray emitter (100), hollow needle body (110) comprises a material selected from a group consisting of borosilicate glass, glass-ceramic, aluminosilicate, quartz, and combinations of these materials. In some preferred embodiments, hollow needle body (110) comprises borosilicate glass. Material for hollow needle body (110) should be sufficiently mechanically strong as to withstand the mechanical forces normally encountered in an electrospray process.

Fluid inlet (120) is shown in FIG.1B in an end-on cross-sectional view (not showing a distal outlet orifice in this cross-sectional view), which in this embodiment is shown as having a circular geometry with inner diameter (122). However, the geometry of fluid inlet (120) need not be circular. Fluid inlet (120) can comprise any of a variety of cross-sectional geometries other than circular including, for example, oval, square, rectangular, hexagonal, and the like. For any of the cross-sectional geometries, inner diameter (122) can more generally be referred to as being a “hydraulic diameter” (for a definition of “hydraulic diameter”, see the “Definitions” section herein). In some embodiments, fluid inlet (120) has a hydraulic inner diameter (122) in a range from about 0.1 micrometer to about 20 micrometers. In some embodiments, fluid inlet (120) has a hydraulic inner diameter (122) of at least about 0.1 micrometer, at least about to about 0.5 micrometers, at least about 1 micrometer, at least about 10 micrometers, at least about 20 micrometers, at least about 50 micrometers, at least about 100 micrometers, at least about 200 micrometers, or even at least about 500 micrometers. In some embodiments, fluid inlet (120) has a hydraulic inner diameter (122) of up to about 20 micrometers, up to about 15 micrometers, up to about 10 micrometers, up to about 5 micrometers, up to about 2 micrometers, or even up to about 1 micrometer.

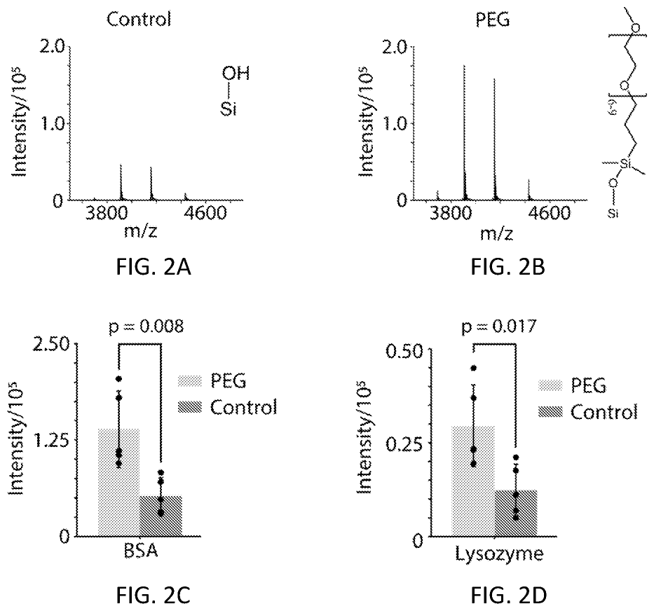

Outlet orifice (130) is shown in FIG. 2C in an end-on view, which in this embodiment is shown as having a circular geometry with inner diameter (132). However, the geometry of outlet orifice (130) need not be circular. Outlet orifice (130) can comprise any of a variety of cross-sectional geometries other than circular including, for example, oval, square, rectangular, hexagonal, and the like. For any of these geometries, the inner diameter (132) of outlet orifice (130) can be referred to as a hydraulic diameter.

In some embodiments of electrospray needle (100), outlet orifice (130) has a hydraulic inner diameter (132) of at least about 0.1 micrometer, at least about to about 0.5 micrometers, at least about 1 micrometer, at least about 2 micrometers, at least about 5 micrometers, at least about 10 micrometers, at least about 20 micrometers, or even up to at least about 50 micrometers.

In some embodiments of electrospray needle (100), outlet orifice (130) has a hydraulic diameter (132) of up to about 50 micrometers, up to about 20 micrometers, up to about 10 micrometers, up to about 10 micrometers, up to about 5 micrometers, up to about 2 micrometers, up to about 1 micrometer, or even up to about 0.5 micrometer.

The electrospray needle according to embodiment 1, wherein the outlet orifice has a hydraulic diameter in a range of from about 0.1 micrometer to about 50 micrometers, from about 0.1 micrometer to about 20 micrometers, from about 0.1 micrometer to about 10 micrometers, from about 0.1 micrometer to about 5 micrometers, from about 0.1 micrometer to about 2 micrometers, from about 0.1 micrometer to about 1 micrometer, or even from about 0.1 micrometer to about 0.5 micrometer.

Shown in FIG. 1A is interior passage (140), linking fluid inlet (120) and outlet orifice (130) in fluid communication. Interior passage (140) can have a range of cross-sectional hydraulic diameters along the length of the hollow needle body (110). In some embodiments, interior passage (140) can have a range of cross-sectional hydraulic diameters in a range from about 0.1 micrometers to about 20 micrometers. In some embodiments, interior passage (140) has a cross-sectional hydraulic diameter of at least about 0.1 micrometer, at least about to about 0.5 micrometers, at least about 1 micrometer, at least about 10 micrometers, at least about 20 micrometers, at least about 50 micrometers, at least about 100 micrometers, at least about 200 micrometers, or even at least about 500 micrometers. In some embodiments, interior passage (140) has a cross-sectional hydraulic diameter of up to about 20 micrometers, up to about 15 micrometers, up to about 10 micrometers, up to about 5 micrometers, up to about 2 micrometers, or even up to about 1 micrometer.

In some embodiments interior passage (140) has a constant hydraulic diameter along a major segment of hollow needle body (110), until “tapering down” to outlet orifice (130). While the embodiment of hollow needle body (110) in FIG. 1A need not be taken as drawn to scale, inner passage (140) is shown as having a constant cross-sectional diameter along about 85% of the distance from fluid inlet (120) to outlet orifice (130), before tapering down to inner diameter (132) of outlet orifice (130). In some embodiments, the tapering can be linear, as shown in FIG. 1A, or the tapering can have other geometries, for example a convex tapering, a concave tapering, or even a combination of geometries. Any suitable geometry for the tapering can be selected that permits sample analysis to proceed without deleterious effects, for example, clogging of the electrospray needle or interfering with instrument sensitivity or reproducibility of sample analyses.

In an embodiment shown in FIG. 1D, the surface (145) of inner passage (140) comprises organic material (150) covalently bonded to the surface (145). Organic material (150) as shown in FIG. 1D comprises a substituted silane covalently bonded to an oxygen atom on the surface (145) of the inner passage (140). The silane material can be represented as having Formula I:

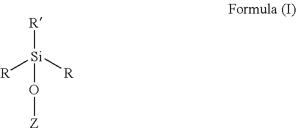

wherein R and R′ can be suitable organic substituents, and “Z” represents an atom integral to the surface (145). For example, in some preferred embodiments, Z can be a silicon atom on a borosilicate glass surface, R can be methyl, and R′ can be a C8 or C18 alkyl group. In another preferred embodiment, Z can again be a silicon atom on a borosilicate glass surface, R can be methyl, and R′ can be a fluorinated group (e.g., “tridecafluoro-_{1,1,2,2}-tetrahydrooctyl” (i.e., CF₃(CF₂)₅CH₂CH₂—)).

In some embodiments according to the invention, the organic material is selected from the group consisting of hydrocarbons, fluorocarbons, carbohydrates, and polyethyleneglycols (“PEG”).

In some embodiments, the organic material is a hydrocarbon. The hydrocarbon can be unbranched or branched, saturated or unsaturated, substituted or unsubstituted heteroalkyl, cycloalkyl, heterocyclylalkyl, aromatic, heteroaromatic.

In some preferred but non-limiting embodiments, the organic material comprises a hydrocarbon with a terminal silane group that can be covalently bonded to surface (145), for example, a C1-C18 alkyl group terminating with a silane group (e.g., octyldimethylsilane and octadecyldimethylsilane).

In some embodiments, the organic material is a fluorocarbon. Fluorocarbon organic materials can include any of the hydrocarbon materials substituted with one, two or more fluorine atoms in place of hydrogen atoms. In the case where all of the hydrogen atoms on the molecule are replaced with fluorine atoms, the organic material is referred to as a “perfluorocarbon”. A non-limiting preferred fluorocarbon organic material that can be covalently bonded to surface (145) is tridecafluoro-1,1,2,2-tetrahydrooctyldimethylsilane (i.e., CF₃(CF₂)₅CH₂CH₂Si(CH₃)₂—).

In some embodiments, the organic material is a carbohydrate. A carbohydrate can include a hydrocarbon with numerous hydroxyl substituents in any arrangement of different positions and stereochemistry, and carbohydrate polymers such as dextran, and other suitable functionalized carbohydrate polymers, such as polysulfonated compounds.

In some embodiments, the organic material is a polyethylene glycol (“PEG”). In some nonlimiting embodiments, the PEG material has a molecular weight of about 500-700 Da, or up to about 2000 Da, or even up to about 5000 Da. used herein, a PEG is linear polymer having repeating “'CH₂CH₂O—” units, terminating at one end with-OH or-OR (where R is a hydrocarbon according to the definition herein), and at the opposite end with a group suitable for forming a covalent bond with surface (145), for example, a silane. PEG-triethoxysilanes for covalent surface modifications are commercially available, for example, from Biopharma PEG, (Watertown, MA), and from Polysciences (Warrington, PA).

Methods for attaching a PEG triethoxysilane to a glass surface can be found in, for example, Yidi et al.

In some embodiments, the organic material has a molecular weight of up to about 300 Da, up to about 400 Da, up to about 500 Da, up to about 600 Da, up to about 700 Da, up to about 800 Da, up to about 900 Da, up to about 1000 Da, up to about 1200 Da, up to about 1400 Da, up to about 1600 Da, up to about 1800 Da, or even up to about 2000 Da.

In embodiments of the invention, the organic material (150) covalently bonded to surface (145) is non-ionizable, i.e., substantially incapable (including incapable) of spontaneously acting as a Bronsted acid or base, or dissociating into ionic species, in water (e.g., at standard temperature and pressure). Without wishing to be bound by theory, an advantage of organic material (150) being non-ionizable can include minimization of ionic interaction between a sample of analyte and surface (145), which could lead to buildup of materials in internal passage (140) and at least partially clogging the electrospray needle.

In embodiments of the invention, organic material (150) covalently bonded to surface (150) is electrically non-conductive. “Electrical non-conductivity” refers to a lack of ability to transport an electric current. Electrically non-conductive materials typically correspond to those materials within which an electric current has little or no tendency to flow. One measure of electrical non-conductivity of a material is its resistivity expressed in ohm meter (“(Ω·m”). Herein, the material is considered to be electrically non-conductive if its resistivity is greater than 10⁶ Ω·m. The resistivity of a material may vary with temperature. Thus, unless otherwise specified, the resistivity of a material is defined at room temperature.

In some embodiments, organic material (150) has a resistivity at 25° C. of at least 10⁶Ω·m, at least 10⁷ Ω·m, at least 10⁸ Ω·m, at least 10⁹ Ω·m, at least 10¹⁰ Ω·m, at least 10¹¹ Ω·m, at least 10¹² Ω·m, at least 10¹³ Ω·m, at least 10¹⁴ Ω·m, at least 10¹⁵ (2. cm, at least 10¹⁶ (2·cm, at least 10¹⁷ Ω·m, or even at least 10¹⁸ Ω·m.

In some embodiments of the invention, organic material (15) is hydrophilic. A material is said to be hydrophilic if a droplet of water on the surface of the material has a contact angle of less than about 90 degrees. Examples of suitable hydrophilic organic material (150) can include, for example, polyethylene glycols and carbohydrates.

In some embodiments of the invention, organic material (150) is hydrophobic. A material is said to be hydrophobic if a droplet of water on the surface of the material has a contact angle of greater than about 90 degrees. In some embodiments, a covalently-bonded hydrophobic organic material has a water contact angle in a range of at least about 90°, about 100°, about 110°, about 120°, about 130°, about 140°, about 150°, about 160°, about 165°, about 170°, or even about 175°, when measured at 18° C. to 23° C. Examples of suitable organic material (150) covalently bonded to surface (145) of interior passage (140) can include, for example, C1-C18 hydrocarbons, polyacrylates, and polystyrenes.

In some embodiments of the invention, organic material (150) is oleophobic. A material is said to be oleophobic if a droplet of an oil (e.g., hexadecane) on the surface of the material has a contact angle of greater than about 50 degrees. In some embodiments, a covalently-bonded oleophobic organic material has an oil contact angle that is at least about 50°, at least about 60°, at least about 70°, about 80°, about 90°, about 100°, about 110°, about 120°, about 130°, about 140°, about 150°, about 160°, about 165°, about 170°, or even about 175°, when measured at 18° C. to 23° C. Examples of a suitable oleophobic organic material (150) covalently bonded to surface (145) of interior passage (140) can include, for example, some polyethylene glycols.

In some embodiments of the invention, organic material (150) is amphiphobic. A material is said to be amphiphobic when it is both hydrophobic and oleophobic. Accordingly an amphiphobic material has both a water contact angle in a range of at least about 90°, about 100°, about 110°, about 120°, about 130°, about 140°, about 150°, about 160°, about 165°, about 170°, or even about 175°, when measured at 18° C. to 23° C., and has an oil contact angle that is at least about 50°, at least about 60°, at least about 70°, about 80°, about 90°, about 100°, about 110°, about 120°, about 130°, about 140°, about 150°, about 160°, about 165°, about 170°, or even about 175°, when measured at 18° C. to 23° C. Examples of suitable amphiphobic organic materials (150) covalently bonded to surface (145) of inner passage (140) can include, for example, tridecafluoro-1,1,2,2-tetrahydrooctyldimethylsilane, and longer chain fluorocarbons or perfluorocarbons (e.g., polytetrafluoroethylene).

In some nonlimiting embodiments, covalent surface modification of a borosilicate glass surface can be accomplished by treatment of the surface with a reactive silylation reagent. Suitable reactive silylation reagents can include, for example, ethyldimethylchlorosilane (EDCS), n-octyldimethylchlorosilane (ODCS), 3,3,3-trifluoropropyldimethylchlorosilane (FPDCS), trimethylchlorosilane TCS), (tridecafluoro-1,1,2,2-tetrahydrooctyl)trichlorosilane (PFTCS), (tridecafluoro-1,1,2,2-tetrahydrooctyl)dimethylchlorosilane (PFDCS), (heptadecafluoro-1,1,2,2-tetrahydrodecyl)dimethylchlorosilane (PFDDCS), 3-cyanopropyldimethylchlorosilane (CPDCS), and combinations thereof.

In some non-limiting embodiments, the organic material (150) can be covalently bound evenly across the surface (145) of interior passage (140). For example, borosilicate glass capillaries can be treated with a silylation reagent that includes a reactive silane (e.g., a silyl chloride or silyl alkoxide) to covalently bond organic groups appended to the silicon atom, using methods known to those having skill in the art (see, for example, Gidi, Y. et al., 2018). For example, silylation of borosilicate glass can be carried out using a solution of an organosilyl chloride or alkoxide in a suitable solvent, for example, toluene.

Exemplary silylation reagents included octyldimethylchlorosilane (ODCS) and (tridecafluoro-1, 1,2,2-tetrahydrooctoyl)dimethyl-chlorosilane (PFDCS). Surface modification of glass with octyldimethylchlorosilane (ODCS) and (tridecafluoro-1,1,2,2-tetrahydrooctyl)dimethyl-chlorosilane (PFDCS) is described in U.S. Published Patent Application No. 2018/0297029 (filed Apr. 16, 2018), the entirety of which incorporated herein by reference.

In some non-limiting embodiments according to the invention, a mass spectrometry system provided that includes an ion source and a detector. The ion source includes an electrospray needle (100) and an electrode positioned with respect to electrospray needle (100). The detector is positioned with respect to electrospray needle (100) and the electrode, to enable ionization of molecules of an analyte.

In some non-limiting embodiments according to the invention a method of detecting an analyte using a mass spectrometry system according to the invention, the method including steps of:
a) urging a sample of the analyte disposed in a carrier fluid through the electrospray needle of the mass spectrometry system according to claim 15 toward the electrode of the mass spectrometry system:
b) applying a voltage to the electrode, thereby forming ionized molecules of the analyte in the sample exiting the outlet orifice: and
c) detecting the ionized molecules of the analyte with the detector positioned with respect to the electrospray needle and the electrode to detect the ionized molecules.

In some embodiments of the method of detecting an analyte using a mass spectrometry system according to the present invention, the analyte is a biomolecule. A wide range of suitable biomolecules is contemplated, including, for example, proteins, lipid, nucleic acids, metabolites, carbohydrates, and complexes and combinations of these.

Although the present invention has been described herein as being useful in analysis of peptides, proteins, and other macromolecules, the present invention is also applicable for use in other fields such as high throughput screening for drug discovery, chemical analysis, or chemical processing.

Emitter tips (electrospray needles) can be prepared according to at least two methods. In the first method, the glass capillary from which the tips are prepared is first modified with silane modifier by immersion in a liquid solution. The result is a silane modified capillary that can then be pulled using a heated filament or other device into an emitter tip. As an example of the first method, capillaries were coated prior to pulling into nESI needles according to the following protocol. First, borosilicate glass capillaries were cleaned, and the surface was activated by immersion in a 1 M HNO3 solution for 30 min. Note, this is a strong acid solution and should be handled with care. Next, the capillaries were rinsed consecutively with nanopure water and 100% ethanol before being dried in a vacuum overnight. Once dried, the glass capillaries were quickly submerged in 2% silane (e.g. PEG6-9-dimethylchlorosilane) in dry acetonitrile (v/v). The reaction was allowed to proceed for 12 h at room temperature. For the PFDCS modification, the glass capillaries were submerged into 2% PFDCS in dry toluene (v/v). The reaction with PFDCS was allowed to proceed for 6 h at room temperature. Following the surface modification, excess silane was removed with successive rinsing with acetonitrile/toluene, acetone, water, and ethanol, and the capillaries were dried and stored in vacuum before being pulled into nESI needles

In the second method, the tips are first prepared from capillaries that have been cleaned, but not chemically modified with a silane modifier. Following formation via pulling, the emitter tip is subsequently modified using a gas-phase reaction with vaporized silane materials. This enables the three-dimensional structure of the tip to be fabricated prior to addition of the silane layer, which may be advantageous in many environments. As an example of the second method, pulled needles were activated by immersion in a IM HNO₃ for 30 min. Next, the needles were rinsed consecutively with nanopure water and pure ethanol before being dried in a 170° C. oven for 1h. Once dried, the needles were assembled into a home-made silanization chamber. 200 microliters of PFDCS was added into the silanization chamber and heated on a hotplate for 10 min. Following the surface modification, excess silane was removed with successive rinsing with acetonitrile/toluene, acetone, water, and ethanol.

### LIST OF EMBODIMENTS

### UAZ-024PCT0

### List of Embodiments

Embodiment 1 is an electrospray needle comprising:
a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage:
   wherein the first organic material is electrically non-conductive and non-ionizable:
   wherein the fluid inlet has a first cross-sectional area, and the outlet orifice has a second cross-sectional area: and
   wherein the first cross-sectional area is greater than the second cross-sectional area.

Embodiment 2 is the electrospray needle of Embodiment 1, wherein the hollow needle body comprises a material selected from the group consisting of a borosilicate glass, a glass-ceramic, an aluminosilicate, quartz, a fused silica, and combinations thereof.

Embodiment 3 is the electrospray needle of Embodiment 1 or Embodiment 2, further comprising a second organic material covalently bonded to at least a portion of the outer surface.

Embodiment 4 is the electrospray needle of Embodiment 3, wherein the second organic material is the same as the first organic material.

Embodiment 5 is the electrospray needle of any one of the preceding embodiments,
wherein at least a portion of the outer surface comprises a coating of an electrically conductive material.

Embodiment 6 is the electrospray needle of Embodiment 5, wherein the electrically conductive material comprises an electrically conductive metal.

Embodiment 7 is the electrospray needle of Embodiment 6, wherein the electrically conductive metal is selected from the group consisting of gold, palladium, platinum, and combinations thereof.

Embodiment 8 is the electrospray needle of Embodiment 7, wherein the electrically conductive metal is gold.

Embodiment 9 is the electrospray needle of any one of Embodiments 5 to 8, wherein the outer surface comprises a coating of the electrically conductive metal.

Embodiment 10 is the electrospray needle of Embodiment 9 wherein the outer surface is substantially free of organic material.

Embodiment 11 is the electrospray needle according to any one of the preceding Embodiments, wherein the hollow needle body comprises borosilicate glass.

Embodiment 12 is the electrospray needle according to any one of the preceding Embodiments, wherein the interior passage has a hydraulic diameter of at least about 0.1 micrometer, at least about to about 0.5 micrometers, at least about 1 micrometer, at least about 5 micrometers, at least about 10 micrometers, at least about 20 micrometers, at least about 50 micrometers, at least about 100 micrometers, at least about 200 micrometers, or even at least about 500 micrometers.

Embodiment 13 is the electrospray needle according to any one of the preceding Embodiments, wherein the interior passage has a hydraulic diameter of up to about 20 micrometers, up to about 15 micrometers, up to about 10 micrometers, up to about 5 micrometers, up to about 2 micrometers, up to about 1 micrometer, or even up to about 0.5 micrometers.

Embodiment 14 is the electrospray needle according to any one of the preceding Embodiments, wherein the interior passage has a hydraulic diameter in a range of from about 0.1 micrometer to about 500 micrometers, from about 0.5 micrometers to about 200 micrometers, from about 0.5 micrometers to about 100 micrometers, from about 0.5 micrometers to about 50 micrometers, from about 0.5 micrometers to about 20 micrometers, from about 0.5 micrometers to about 10 micrometers, from about 1 micrometer to about 10 micrometers, from about 0.5 micrometers to about 5 micrometers, or even from about 1 micrometer to about 5 micrometers.

Embodiment 15 is the electrospray needle according any one of the preceding Embodiments, wherein the outlet orifice has a hydraulic diameter of at least about 0.1 micrometer, at least about to about 0.5 micrometers, at least about 1 micrometer, at least about 2 micrometers, at least about 5 micrometers, at least about 10 micrometers, at least about 20 micrometers, or even up to at least about 50 micrometers.

Embodiment 16 is the electrospray needle according to any one of the preceding Embodiments, wherein the outlet orifice has a hydraulic diameter of up to about micrometers, up to about 20 micrometers, up to about 10 micrometers, up to about 10 micrometers, up to about 5 micrometers, up to about 2 micrometers, up to about 1 micrometer, or even up to about 0.5 micrometer.

Embodiment 17 is the electrospray needle according to any one of the preceding Embodiments, wherein the outlet orifice has a hydraulic diameter in a range of from about 0.1 micrometer to about 50 micrometers, from about 0.1 micrometer to about 20 micrometers, from about 0.1 micrometer to about 10 micrometers, from about 0.1 micrometer to about 5 micrometers, from about 0.1 micrometer to about 2 micrometers, from about 0.1 micrometer to about 1 micrometer, or even from about 0.1 micrometer to about 0.5 micrometer.

Embodiment 18 is the electrospray needle according to any one of the preceding Embodiments, wherein the interior passage has a length, a major axis, and the surface of the interior passage is concentric around the major axis throughout the length of the axis.

Embodiment 19 is the electrospray needle according to any one of the preceding Embodiments, wherein the interior passage has a length, a major axis, and a cross-section perpendicular to the major axis, wherein said cross-section is circular and is centered about the major axis throughout the length of the interior passage.

Embodiment 20 is the electrospray needle according to any one of the preceding Embodiments, wherein the outlet orifice is circular.

Embodiment 21 is the electrospray needle according to any one of the preceding Embodiments, wherein the outlet orifice has a geometry other than circular (e.g., elliptical, triangular, square, rectangular, star-shaped, irregularly shaped, among other non-circular geometries).

Embodiment 22 is the electrospray needle according to any one of the preceding Embodiments, wherein the end of the hollow needle body comprising the outlet orifice comprises a beveled tip.

Embodiment 23 is the electrospray needle according to any one of the preceding Embodiments, wherein the fluid inlet is circular.

Embodiment 24 is the electrospray needle according to any one of the preceding Embodiments, wherein the fluid inlet has a geometry other than circular (e.g., elliptical, triangular, square, rectangular, star-shaped, irregularly shaped, among other non-circular geometries).

Embodiment 25 is the electrospray needle according to any one of the preceding Embodiments, wherein the needle has a length in a range of from about 10 mm to about 100 mm, from about 10 mm to about 90 mm, from about 10 mm to about 80 mm, from about 10 mm to about 70 mm, from about 10 mm to about 60 mm, from about 10 mm to about 50 mm, from about 10 mm to about 40 mm, from about 10 mm to about 30 mm, from about 10 mm to about 20 mm, from about 10 mm to about 15 mm, or even about 10 mm.

Embodiment 26 is the electrospray needle according to any one of the preceding Embodiments, wherein the first organic material covers at least 10%, at least 20%, at least 30%, at least 40%, at least 50%, at least 60%, at least 70%, at least 80%, at least 90%, at least 95%, or even 100% of the surface of the interior passage.

Embodiment 27 is the electrospray needle according to any one of the preceding Embodiments, wherein the first organic material is covalently-bonded to the surface of the interior passage at least proximal to the outlet orifice.

Embodiment 28 is the electrospray needle according to any one of the preceding Embodiments, wherein at least a portion of the exterior surface of the hollow needle is modified with the covalently-bonded organic material.

Embodiment 29 is the electrospray needle according to any one of the preceding Embodiments, wherein at least 10%, at least 20%, at least 30%, at least 40%, at least 50%, at least 60%, at least 70%, at least 80%, at least 90%, at least 95%, or even 100% of the exterior surface of the hollow needle is modified with the covalently-bonded organic material.

Embodiment 30 is the electrospray needle according to any one of the preceding Embodiments, wherein a segment of the interior passage proximal to the outlet orifice tapers toward the outlet orifice over a length of from about 1 mm to about 20 mm, from about 1 mm to about 20 mm, from about 1 mm to about 10 mm, from about 1 mm to about 5 mm, or even from about 1 mm to about 2 mm.

Embodiment 31 is the electrospray needle according to any one of the preceding Embodiments, wherein the first organic material is selected from the group consisting of hydrocarbons, fluorocarbons, carbohydrates, and polyethylene glycols, and combinations thereof.

Embodiment 32 is the electrospray needle according to any one of the preceding Embodiments, wherein the first organic material is resistant to water and organic solvents.

Embodiment 33 is the electrospray needle according to any one of the preceding Embodiments, wherein the first organic material comprises a hydrocarbon.

Embodiment 34 is the electrospray needle according to any one of the preceding Embodiments, wherein the first organic material comprises a carbohydrate, (for example, dextrose and agarose).

Embodiment 35 is the electrospray needle according to any one of the preceding Embodiments, wherein the first organic material comprises a polyethylene glycol.

Embodiment 36 is the electrospray needle according to any one of the preceding Embodiments, wherein the first organic material comprises a fluorocarbon.

Embodiment 37 is the electrospray needle according to any one of the preceding Embodiments, wherein the first organic material is (tridecafluoro-1,1,2,2-tetrahydrooctyl)silane.

Embodiment 38 is the electrospray needle according to any one of the preceding Embodiments, wherein the first organic material has a molecular weight of up to about 300 Da, up to about 400 Da, up to about 500 Da, up to about 600 Da, up to about 700 Da, up to about 800 Da, up to about 900 Da, up to about 1000 Da, up to about 1200 Da, up to about 1400 Da, up to about 1600 Da, up to about 1800 Da, or even up to about 2000 Da.

Embodiment 39 is the electrospray needle according to any one of the preceding Embodiments, wherein the first organic material is hydrophilic, hydrophobic, oleophobic, or amphiphobic.

Embodiment 40 is the electrospray needle according to any one of the preceding Embodiments, wherein the first organic material is hydrophilic.

Embodiment 41 is the electrospray needle according to any one of the preceding Embodiments, wherein the first organic material has a water contact angle of less than about 90°.

Embodiment 42 is the electrospray needle according to any one of the preceding Embodiments, wherein the first organic material is hydrophobic.

Embodiment 43 is the electrospray needle according to any one of the preceding Embodiments, wherein the interior passage having the covalently-bonded organic material has a water contact angle in a range of at least about 90°, about 100°, about 110°, about 120°, about 130°, about 140°, about 150°, about 160°, about 165°, about 170°, or even about 175°, when measured at 18° C. to 23° C.

Embodiment 44 is the electrospray needle according to any one of the preceding Embodiments, wherein the first organic material is oleophobic.

Embodiment 45 is the electrospray needle according to any one of the preceding Embodiments, wherein the first organic material has an oil contact angle that is at least about 50°, at least about 60°, at least about 70°, about 80°, about 90°, about 100°, about 110°, about 120°, about 130°, about 140°, about 150°, about 160°, about 165°, about 170°, or even about 175°, when measured at 18° C. to 23° C.

Embodiment 46 is the electrospray needle according to any one of the preceding Embodiments, wherein the first organic material is amphiphobic.

Embodiment 47 is the electrospray needle according to any one of the preceding Embodiments, wherein the first organic material has a water contact angle in a range of at least about 90°, about 100°, about 110°, about 120°, about 130°, about 140°, about 150°, about 160°, about 165°, about 170°, or even about 175°, when measured at 18° C. to 23° C., and has an oil contact angle that is at least about 70°, about 80°, about 90°, about 100°, about 110°, about 120°, about 130°, about 140°, about 150°, about 160°, about 165°, about 170°, or even about 175°, when measured at 18° C. to 23° C.

Embodiment 48 is the electrospray needle according to any one of the preceding Embodiments, wherein the first organic material comprises a silane group.

Embodiment 49 is the electrospray needle according to any one of the preceding Embodiments, wherein the first organic material is covalently bonded to the surface of inner passage (140) by exposing the surface of the interior passage to a silylation reagent selected from the group consisting of ethyldimethylchlorosilane (EDCS), n-octyldimethylchlorosilane (ODCS), 3,3,3-trifluoropropyldimethylchlorosilane (FPDCS), trimethylchlorosilane TCS), (tridecafluoro-1,1,2,2-tetrahydrooctyl)trichlorosilane (PFTCS), (tridecafluoro-1,1,2,2-tetrahydrooctyl)dimethylchlorosilane (PFDCS), (heptadecafluoro-1,1,2,2-tetrahydrodecyl)dimethylchlorosilane 3-cyanopropyldimethylchlorosilane (PFDDCS), (CPDCS), and combinations thereof.

Embodiment 50 is the electrospray needle according to any one of the preceding Embodiments, wherein the first organic material is covalently bonded to the surface of the inner passage by reaction with a silylation reagent selected from the group consisting of n-octyldimethylchlorosilane (ODCS), 3,3,3-trifluoropropyldimethylchlorosilane (FPDCS), and combinations thereof.

Embodiment 51 is the electrospray needle according to any one of the preceding Embodiments, wherein the organic material has a resistivity at 25° C. of at least at least 10⁶ Ω·m, at least 10⁷ Ω·m, at least 10⁸ Ω·m, at least 10⁹ Ω·m, at least 10¹⁰ Ω·m, at least 10¹¹ Q2. m, at least 10¹² Ω·m, at least 10¹³ Ω·m, at least 10¹⁴ Ω·m, at least 10^{15 02}. cm, at least 10¹⁶ (2. cm, at least 10¹⁷ Ω·m, or even at least 10¹⁸ Ω·m.

Embodiment 52 is an electrospray needle comprising:
a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage:
   wherein the first organic material is electrically non-conductive and non-ionizable:
   wherein the fluid inlet has a first cross-sectional area, and the outlet orifice has a second cross-sectional area:
   wherein the first cross-sectional area is greater than the second cross-sectional area: and
   wherein at least a portion of the outer surface comprises a coating of an electrically conductive material.

Embodiment 53 is the electrospray needle of Embodiment 52, wherein the hollow needle body comprises a material selected from the group consisting of a borosilicate glass, a glass-ceramic, an aluminosilicate, quartz, a fused silica, and combinations thereof. Embodiment 54 is the electrospray needle of any one of Embodiment 52 and

Embodiment 53, further comprising a second organic material covalently bonded to at least a portion of the outer surface.

Embodiment 55 is the electrospray needle of Embodiment 55, wherein the second organic material is the same as the first organic material.

Embodiment 56 is the electrospray needle of any one of Embodiments 52 to 55, wherein the electrically conductive material comprises an electrically conductive metal.

Embodiment 57 is the electrospray needle of Embodiment 56, wherein the electrically conductive metal is selected from the group consisting of gold, palladium, platinum, and combinations thereof.

Embodiment 58 is the electrospray needle of Embodiment 57, wherein the electrically conductive metal is gold.

Embodiment 59 is the electrospray needle of any one of Embodiments 50 and 51, wherein the coating of the electrically conductive metal is a coating over the second organic material.

Embodiment 60 is the electrospray needle of any one of Embodiments 52-53, and 55-59, wherein the outer surface is substantially free of organic material.

Embodiment 61 is the electrospray needle according to any one of the preceding Embodiments wherein the hollow needle body comprises borosilicate glass.

Embodiment 62 is the electrospray needle according to any one of the preceding Embodiments, wherein the interior passage has a hydraulic diameter of at least about 0.1micrometer, at least about to about 0.5 micrometers, at least about 1 micrometer, at least about 5 micrometers, at least about 10 micrometers, at least about 20 micrometers, at least about 50 micrometers, at least about 100 micrometers, at least about 200 micrometers, or even at least about 500 micrometers.

Embodiment 63 is the electrospray needle according to any one of the preceding Embodiments, wherein the interior passage has a hydraulic diameter of up to about 20 micrometers, up to about 15 micrometers, up to about 10 micrometers, up to about 5 micrometers, up to about 2 micrometers, up to about 1 micrometer, or even up to about 0.5 micrometers.

Embodiment 64 is the electrospray needle according to any one of the preceding Embodiments, wherein the interior passage has a hydraulic diameter in a range of from about 0.1 micrometer to about 500 micrometers, from about 0.5 micrometers to about 200 micrometers, from about 0.5 micrometers to about 100 micrometers, from about 0.5 micrometers to about 50 micrometers, from about 0.5 micrometers to about 20 micrometers, from about 0.5 micrometers to about 10 micrometers, from about 1 micrometer to about 10 micrometers, from about 0.5 micrometers to about 5 micrometers, or even from about 1 micrometer to about 5 micrometers.

Embodiment 65 is the electrospray needle according any one of the preceding Embodiments, wherein the outlet orifice has a hydraulic diameter of at least about 0.1 micrometer, at least about to about 0.5 micrometers, at least about 1 micrometer, at least about 2 micrometers, at least about 5 micrometers, at least about 10 micrometers, at least about 20 micrometers, or even up to at least about 50 micrometers.

Embodiment 66 is the electrospray needle according to any one of the preceding Embodiments, wherein the outlet orifice has a hydraulic diameter of up to about micrometers, up to about 20 micrometers, up to about 10 micrometers, up to about 10 micrometers, up to about 5 micrometers, up to about 2 micrometers, up to about 1 micrometer, or even up to about 0.5 micrometer.

Embodiment 67 is the electrospray needle according to any one of the preceding Embodiments, wherein the outlet orifice has a hydraulic diameter in a range of from about 0.1 micrometer to about 50 micrometers, from about 0.1 micrometer to about 20 micrometers, from about 0.1 micrometer to about 10 micrometers, from about 0.1 micrometer to about 5 micrometers, from about 0.1 micrometer to about 2 micrometers, from about 0.1 micrometer to about 1 micrometer, or even from about 0.1 micrometer to about 0.5 micrometer.

Embodiment 68 is the electrospray needle according to any one of the preceding Embodiments, wherein the interior passage has a length, a major axis, and the surface of the interior passage is concentric around the major axis throughout the length of the axis.

Embodiment 69 is the electrospray needle according to any one of the preceding Embodiments, wherein the interior passage has a length, a major axis, and a cross-section perpendicular to the major axis, wherein said cross-section is circular and is centered about the major axis throughout the length of the interior passage.

Embodiment 70 is the electrospray needle according to any one of the preceding Embodiments, wherein the outlet orifice is circular.

Embodiment 71 is the electrospray needle according to any one of the preceding Embodiments, wherein the outlet orifice has a geometry other than circular (e.g., elliptical, triangular, square, rectangular, star-shaped, irregularly shaped, among other non-circular geometries).

Embodiment 72 is the electrospray needle according to any one of the preceding Embodiments, wherein the end of the hollow needle body comprising the outlet orifice comprises a beveled tip.

Embodiment 73 is the electrospray needle according to any one of the preceding Embodiments, wherein the fluid inlet is circular.

Embodiment 74 is the electrospray needle according to any one of the preceding Embodiments, wherein the fluid inlet has a geometry other than circular (e.g., elliptical, triangular, square, rectangular, star-shaped, irregularly shaped, among other non-circular geometries).

Embodiment 75 is electrospray needle according to any one of the preceding embodiments, wherein the needle has a length in a range of from about 10 mm to about 100 mm, from about 10 mm to about 90 mm, from about 10 mm to about 80 mm, from about 10 mm to about 70 mm, from about 10 mm to about 60 mm, from about 10 mm to about 50 mm, from about 10 mm to about 40 mm, from about 10 mm to about 30 mm, from about 10 mm to about 20 mm, from about 10 mm to about 15 mm, or even about 10 mm.

Embodiment 76 is the electrospray needle according to any one of the preceding Embodiments, wherein the first organic material covers at least 10%, at least 20%, at least 30%, at least 40%, at least 50%, at least 60%, at least 70%, at least 80%, at least 90%, at least 95%, or even 100% of the surface of the interior passage.

Embodiment 77 is the electrospray needle according to any one of the preceding Embodiments, wherein the first organic material is covalently-bonded to the surface of the interior passage at least proximal to the outlet orifice.

Embodiment 78 is the electrospray needle according to any one of the preceding Embodiments, wherein at least a portion of the exterior surface of the hollow needle is modified with the covalently-bonded organic material.

Embodiment 79 is the electrospray needle according to any one of the preceding Embodiments, wherein at least 10%, at least 20%, at least 30%, at least 40%, at least 50%, at least 60%, at least 70%, at least 80%, at least 90%, at least 95%, or even 100% of the exterior surface of the hollow needle is modified with the covalently-bonded organic material.

Embodiment 80 is the electrospray needle according to any one of the preceding Embodiments, wherein a segment of the interior passage proximal to the outlet orifice tapers toward the outlet orifice over a length of from about 1 mm to about 20 mm, from about 1 mm to about 20 mm, from about 1 mm to about 10 mm, from about 1 mm to about 5 mm, or even from about 1 mm to about 2 mm.

Embodiment 81 is the electrospray needle according to any one of the preceding Embodiments, wherein the first organic material is selected from the group consisting of hydrocarbons, fluorocarbons, carbohydrates, and polyethylene glycols, and combinations thereof.

Embodiment 82 is the electrospray needle according to any one of the preceding Embodiments, wherein the first organic material is resistant to water and organic solvents.

Embodiment 83 is the electrospray needle according to any one of the preceding Embodiments, wherein the first organic material comprises a hydrocarbon.

Embodiment 84 is the electrospray needle according to any one of the preceding Embodiments, wherein the first organic material comprises a carbohydrate, (for example, dextrose and agarose).

Embodiment 85 is the electrospray needle according to any one of the preceding Embodiments, wherein the first organic material comprises a polyethylene glycol.

Embodiment 86 is the electrospray needle according to any one of the preceding Embodiments, wherein the first organic material comprises a fluorocarbon.

Embodiment 87 is the electrospray needle according to any one of the preceding Embodiments, wherein the first organic material is (tridecafluoro-1,1,2,2-tetrahydrooctyl)silane.

Embodiment 88 is the electrospray needle according to any one of the preceding Embodiments, wherein the first organic material has a molecular weight of up to about 300 Da, up to about 400 Da, up to about 500 Da, up to about 600 Da, up to about 700 Da, up to about 800 Da, up to about 900 Da, up to about 1000 Da, up to about 1200 Da, up to about 1400 Da, up to about 1600 Da, up to about 1800 Da, or even up to about 2000 Da.

Embodiment 89 is the electrospray needle according to any one of the preceding Embodiments, wherein the first organic material is hydrophilic, hydrophobic, oleophobic, or amphiphobic.

Embodiment 90 is the electrospray needle according to any one of the preceding Embodiments, wherein the first organic material is hydrophilic.

Embodiment 91 is the electrospray needle according to any one of the preceding Embodiments, wherein the first organic material has a water contact angle of less than about 90°.

Embodiment 92 is the electrospray needle according to any one of the preceding Embodiments, wherein the first organic material is hydrophobic.

Embodiment 93 is the electrospray needle according to any one of the preceding Embodiments, wherein the interior passage having the covalently-bonded organic material has a water contact angle in a range of at least about 90°, about 100°, about 110°, about 120°, about 130°, about 140°, about 150°, about 160°, about 165°, about 170°, or even about 175°, when measured at 18° C. to 23° C.

Embodiment 94 is the electrospray needle according to any one of the preceding Embodiments, wherein the first organic material is oleophobic.

Embodiment 95 is the electrospray needle according to any one of the preceding Embodiments, wherein the first organic material has an oil contact angle that is at least about 50°, at least about 60°, at least about 70°, about 80°, about 90°, about 100°, about 110°, about 120°, about 130°, about 140°, about 150°, about 160°, about 165°, about 170°, or even about 175°, when measured at 18° C. to 23° C.

Embodiment 96 is the electrospray needle according to any one of the preceding Embodiments, wherein the first organic material is amphiphobic.

Embodiment 97 is the electrospray needle according to any one of the preceding Embodiments, wherein the first organic material has a water contact angle in a range of at least about 90°, about 100°, about 110°, about 120°, about 130°, about 140°, about 150°, about 160°, about 165°, about 170°, or even about 175°, when measured at 18° C. to 23° C., and has an oil contact angle that is at least about 70°, about 80°, about 90°, about 100°, about 110°, about 120°, about 130°, about 140°, about 150°, about 160°, about 165°, about 170°, or even about 175°, when measured at 18° C. to 23° C.

Embodiment 98 is the electrospray needle according to any one of the preceding Embodiments, wherein the first organic material comprises a silane group.

Embodiment 99 is the electrospray needle according to any one of the preceding Embodiments, wherein the first organic material is covalently bonded to the surface of inner passage (140) by exposing the surface of the interior passage to a silylation reagent selected from the group consisting of ethyldimethylchlorosilane (EDCS), n-octyldimethylchlorosilane (ODCS), 3,3,3-trifluoropropyldimethylchlorosilane (FPDCS), trimethylchlorosilane TCS), (tridecafluoro-1, 1,2,2-tetrahydrooctyl)trichlorosilane (PFTCS), (tridecafluoro-1,1,2,2-tetrahydrooctyl)dimethylchlorosilane (PFDCS), (heptadecafluoro-1,1,2,2-tetrahydrodecyl)dimethylchlorosilane (PFDDCS), 3-cyanopropyldimethylchlorosilane (CPDCS), and combinations thereof.

Embodiment 100 is the electrospray needle according to any one of the preceding Embodiments, wherein the first organic material is covalently bonded to the surface of the inner passage by reaction with a silylation reagent selected from the group consisting of n-octyldimethylchlorosilane (ODCS), 3,3,3-trifluoropropyldimethylchlorosilane (FPDCS), and combinations thereof.

Embodiment 101 is the electrospray needle according to any one of the preceding Embodiments, wherein the organic material has a resistivity at 25° C. of at least at least 10⁶ Ω·m, at least 10⁷ Ω·m, at least 10⁸ Ω·m, at least 10⁹ Ω·m, at least 10¹⁰ Ω·m, at least 10¹¹ Ω·m, at least 10¹² Ω·m, at least 10¹³ Ω·m, at least 10¹⁴ Ω·m, at least 10¹⁵ (2. cm, at least 10^{16 02}. cm, at least 10¹⁷ Ω·m, or even at least 10¹⁸ Ω·m.

Embodiment 102 is a mass spectrometry system, comprising:
a) an ion source comprising:
   i) an electrospray needle comprising:
      a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage;
   wherein the first organic material is electrically non-conductive and non-ionizable:
   wherein the fluid inlet has a first cross-sectional area, and the outlet orifice has a second cross-sectional area: and
   wherein the first cross-sectional area is greater than the second cross-sectional area;
   ii) an electrode positioned with respect to the electrospray needle:
   wherein, when a sample disposed in a carrier fluid is urged through the electrospray needle toward the electrode, a voltage can be applied to the electrode thereby forming ionized molecules of an analyte in the sample exiting the outlet orifice: and
b) a detector positioned with respect to the electrospray needle and the electrode to detect the ionized molecules.

Embodiment 104 is the mass spectrometry system according to embodiment 103, wherein the electrospray needle is according to any one of Embodiments 1-101.

Embodiment 105 is a mass spectrometry system, comprising:
a) an ion source comprising:
   i) an electrospray needle comprising:
      a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage:
   wherein the first organic material is electrically non-conductive and non-ionizable:
   wherein the fluid inlet has a first cross-sectional area, and the outlet orifice has a second cross-sectional area; and
   wherein the first cross-sectional area is greater than the second cross-sectional area: and
   wherein at least a portion of the outer surface comprises a coating of an electrically conductive material.
   ii) an electrode positioned with respect to the electrospray needle:
   wherein, when a sample disposed in a carrier fluid is urged through the electrospray needle toward the electrode, a voltage can be applied to the electrode thereby forming ionized molecules of an analyte in the sample exiting the outlet orifice: and
b) a detector positioned with respect to the electrospray needle and the electrode to detect the ionized molecules.

Embodiment 106 is the mass spectrometry system according to embodiment 105, wherein the electrically conductive material comprises an electrically conductive metal.

Embodiment 107 is the mass spectrometry system of Embodiment 106, wherein the electrically conductive metal is selected from the group consisting of gold, palladium, platinum, and combinations thereof.

Embodiment 108 is the mass spectrometry system of Embodiment 107, wherein the electrically conductive metal is gold.

Embodiment 109 is a method is provided for detecting an analyte using a mass spectrometry system according to any one of Embodiments 102-107, said method comprising steps of:
a) urging a sample of the analyte disposed in a carrier fluid through the electrospray needle of the mass spectrometry system according to the present invention toward the electrode of the mass spectrometry system;
b) applying a voltage to the electrode, thereby forming ionized molecules of the analyte in the sample exiting the outlet orifice; and
c) detecting the ionized molecules of the analyte with the detector positioned with respect to the electrospray needle and the electrode to detect the ionized molecules. In some embodiments of the method, the analyte is a biomolecule.

Embodiment 110 is a kit, comprising at least one coated electrospray needle according to any one of Embodiments 1 to 101 in a package, optionally including written instructions for use of the at least one electrospray needle. In some embodiments, the kit has a single coated electrospray needle according to any one of Embodiments 1 to 101: in some other embodiments, the kit comprises a plurality of electrospray needles according to any one of Embodiments 1 to 101, and in some embodiments at least two of the electrospray needles in the plurality of electrospray needles are separate and non-identical with each other regarding at least one of: the organic material, the diameter of the outlet orifice, the body material, the length, and disposition of the organic material covalently bonded to the hollow needle body.

Embodiment 111 is a method of making an electrospray needle according to any one of Embodiments 1-101, said method comprising:
a) pulling a capillary tube to form a narrowed midsection:
b) separating the capillary tube at the narrowed midsection to form at least one electrospray needle comprising a hollow needle body, said hollow needle body comprising an outer surface, a fluid inlet, an outlet orifice and an interior passage linking the fluid inlet and the outlet orifice in fluid communication:
c) providing a coating of a first organic material on at least a portion of said interior passage, wherein said first organic material is electrically nonconductive and nonionizable.

Embodiment 112 is the method of Embodiment 111, further comprising providing a coating of an electrically conductive material on at least a portion of the outer surface of the hollow needle body.

Embodiment 113 is the method of any one of Embodiment 111-112, wherein providing the coating of the first organic material comprises coating the interior of the capillary tube prior to separating the capillary tube at the narrowed midsection.

Embodiment 114 is the method of any one of Embodiment 111-112, wherein providing the coating of the first organic material comprises coating the interior passage of the hollow needle body after separating the capillary tube at the narrowed midsection.

Embodiment 115 is the method of any one of Embodiment 112-114, wherein providing the coating of the electrically conductive material comprises coating the exterior surface of the capillary tube prior to separating the capillary tube at the narrowed midsection.

Embodiment 116 is the method of any one of Embodiment 112-114, wherein providing the coating of the electrically conductive material comprises coating the exterior surface of the hollow needle body with the electrically conductive material after separating the capillary tube at the narrowed midsection.

Embodiment 117 is the method of any one of Embodiments 112-114, wherein providing the coating of the first organic material comprises coating the interior passage of the hollow needle body after separating the capillary tube at the narrowed midsection, and wherein providing the coating of the electrically conductive material comprises coating the exterior surface of the hollow needle body with the electrically conductive material after separating the capillary tube at the narrowed midsection.

Embodiment 118 is the method of any one of Embodiments 112-114, wherein providing the coating of the first organic material comprises coating the interior of the capillary tube with the first organic material prior to separating the capillary tube at the narrowed midsection, and wherein providing the coating of the electrically conductive material comprises coating the exterior surface of the hollow needle body with the electrically conductive material after separating the capillary tube at the narrowed midsection.

Embodiment 119 is the method of any one of Embodiments 112-114, wherein providing the coating of the electrically conductive material comprises coating the exterior surface of the capillary tube with the electrically conductive material prior to separating the capillary tube at the narrowed midsection, and wherein providing the coating of the first organic material comprises coating the interior of the capillary tube with the first organic material after separating the capillary tube at the narrowed midsection.

Embodiment 119 is a method of making an electrospray needle according to any one of Embodiments 1-101, said method comprising:
a) pulling a capillary tube to form a narrowed midsection:
b) separating the capillary tube at the narrowed midsection to form at least one electrospray needle comprising a hollow needle body, said hollow needle body comprising an outer surface, a fluid inlet, an outlet orifice and an interior passage linking the fluid inlet and the outlet orifice in fluid communication;
c) providing a coating of a first organic material on at least a portion of said interior passage, wherein said first organic material is electrically nonconductive and nonionizable: and
d) providing a coating of an electrically conductive material on at least a portion of the outer surface of the hollow needle body.

Embodiment 120 is a method of making an electrospray needle according to any one of Embodiments 1-101, said method comprising:
a) coating the interior of a capillary tube with a first organic material, wherein the first organic material is electrically nonconductive and nonionizable:
b) pulling the ends of a capillary tube to form a narrowed midsection:
c) separating the capillary tube at the narrowed midsection to form at least one electrospray needle comprising a hollow needle body comprising an outer surface, a fluid inlet, an outlet orifice and an interior passage linking the fluid inlet and the outlet orifice in fluid communication: wherein said first organic material forms an electrically nonconductive and nonionizable coating on a surface of said interior passage.

Embodiment 121 is a method of making an electrospray needle according to any one of Embodiments 1-101, said method comprising:
a) applying a pulling force to both ends of a capillary (e.g., positioned over a heat source at a midsection of capillary, thereby softening the capillary and forming a narrowed midsection);
b) separating the capillary at the narrowed midsection to form at least one electrospray needle comprising a hollow elongated body, said hollow elongated body comprising an outer surface, a fluid inlet, an outlet orifice, and an inner passage linking the fluid inlet and the outlet orifice in fluid communication, wherein the fluid inlet has a first cross-sectional area, and the outlet orifice has a second cross-sectional area: and wherein the first cross-sectional area is greater than the second cross-sectional area:
c) exposing the hollow elongated bodies to a first organic material comprising a reactive moiety (e.g., a Si—OH or Si—Cl group) to covalently form an electrically non-conductive and non-ionizable coating (e.g., using a solution of the first organic material in a solvent, or in a vapor or gaseous phase):
d) allowing time for the reactive moiety to react with at least a portion of the surface of the inner passage, resulting in an electrospray needle comprising the first organic material covalently bound to at least a portion of the surface of the inner passage.

Embodiment 122 is the method of any one of Embodiments 111 to 121, wherein the coating of the first organic material is applied at a relative humidity of at or less than 20% at ambient temperature.

Embodiment 123 is a method of making an electrospray needle according to any one of embodiments 52-101, said method comprising:
a) applying a pulling force to both ends of a capillary positioned over a heat source at a midsection of capillary, thereby softening the capillary and forming a narrowed midsection:
b) separating the capillary at the narrowed midsection into two hollow elongated bodies, each comprising an outer surface, a fluid inlet, an outlet orifice, and an inner passage linking the fluid inlet and the outlet orifice in fluid communication, wherein the fluid inlet has a first cross-sectional area, and the outlet orifice has a second cross-sectional area; and wherein the first cross-sectional area is greater than the second cross-sectional area.
c) exposing at least one of the hollow elongated bodies to a fluid comprising an organic material having a reactive moiety (e.g., wherein the fluid is either a liquid or a gas):
d) allowing time for the reactive moiety to react with at least a portion of the surface of the inner passage, resulting in an electrospray needle comprising an organic material covalently bound to at least a portion of the surface of the inner passage: and
e) apply a coating of an electrically conductive material to the capillary and/or the hollow elongated body.

### EXAMPLES

The following examples are non-limiting with respect to practicing the present invention. It is to be understood that the examples provided herein are presented for illustrative purposes, and are not intended to limit the invention in any way. Equivalents or substitutes are within the scope of the invention.

Materials.

Ammonium acetate, ubiquitin, BSA, and lysozyme were purchased from Sigma-Aldrich. Glass Capillaries (O.D. 1.2 mm, I.D. 0.68 mm, and 100 mm long) were purchased from World Precision Instruments. AAV2 capsids were purchased from Virovek. Vivaspin 100 kDa molecular weight cutoff filters were purchased from Sartorius. BIOSPIN 6 columns were purchased from Bio-Rad. Octyldimethylchlorosilane (ODCS), 2-[methoxypoly(ethylenoxy)-6-9-propyl]dimethylchlorosilane, (PEG6-9-dimethylchloro-silane) and (tridecafluoro-1,1,2,2-tetrahydrooctyl)-dimethylchlorosilane (PFDCS) were purchased from Gelest, Inc. Anhydrous acetonitrile (ACN) was purchased from Supelco, Inc. Acetone was purchased from EMD Chemical, Inc. Ethanol was purchased from Decon Laboratories.

Protein and AAV Capsid Preparation.

BSA and lysozyme were buffer exchanged using two consecutive Biospin 6 columns (BioRad) into 0.2 M ammonium acetate. AAV capsids were buffer exchanged as previously described (see Kostelic et el., 2021). Briefly, AAV capsids were buffer exchanged by diluting the stock capsids with 0.2 M ammonium acetate and then concentrated using a 100 kDa molecular weight cutoff filter at least two consecutive times. Concentrations of AAV2 were calculated by first denaturing the viral capsids by adding 0.1% SDS and heating to 75° C. for 10 min then taking the average of three A280 measurements with a Denovix Model DS-11+ spectrophotometer. The extinction coefficient for denatured AAV2 at 280 nm has been reported as 6.61×106 M⁻¹ cm⁻¹. Avogadro's number was then used to convert to capsids per ml based off of the measured molarity. This assumes that all the viral proteins form capsids and have a correct stoichiometry, so this is a rough estimate for viral capsid concentration.

Capillary Coating.

Capillaries were coated prior to pulling into nanoelectrospray ionization (nESI) needles. First, borosilicate glass capillaries were cleaned, and the surface was activated by immersion in a 1 M HNO₃ solution for 30 min. (note, this is a strong acid solution and should be handled with care). Next, the capillaries were rinsed consecutively with nanopure water and 100% ethanol before being dried in a vacuum overnight. Once dried, the glass capillaries were quickly submerged in 2% PEG6-9-dimethylchlorosilane in dry acetonitrile (v/v). The reaction was allowed to proceed for 12 h at room temperature. For the PFDCS modification, the glass capillaries were submerged into 2% PFDCS in dry toluene (v/v). The reaction with PFDCS was allowed to proceed for 6 h at room temperature. Following the surface modification, excess silane was removed with successive rinsing with acetonitrile/toluene, acetone, water, and ethanol, and the capillaries were dried and stored in vacuum before being pulled into nESI needles with a P-97 or P-1000 pipet puller (Sutter Instruments). Control needles were pulled with the same program but used capillaries that lacked the coating. All coated capillaries were acid washed, but the control capillaries were not. Unless otherwise noted, capillaries were pulled using the standard pulling program (see Table 1) and were manually clipped under a microscope.

TABLE 1
P-1000 micropipette puller parameters for pulling
nESI needles that were manually clipped.

| LINE | HEAT | PULL | VEL | TIME |
|---|---|---|---|---|
| 1 | Ramp + 5 | 0 | 10 | 200 |
| 2 | Ramp + 10 | 0 | 10 | 200 |
| 3 | Ramp + 15 | 200 | 50 | 80 |

Needles with fixed geometries of either 2 or 0.1 micrometer were pulled using different programs (see Table 2 for the 2 micrometer needles, and see below regarding the 0.1micrometer electrospray emitters) and did not need manual clipping. It was important to keep the modified capillaries in a vacuum or a desiccator for long-term storage. Even in a dry climate, needles left on the bench for a week reacted with water vapor in the air and released PEG that contaminated the sample to some degree.

TABLE 2
P-97 micropipette puller parameters for pulling consistent 2 micrometer
ESI needles that do not need to be manually clipped.

| LINE | HEAT | PULL | VEL | TIME |
|---|---|---|---|---|
| 1 | Ramp + 45 | 5 | 17 | 100 |
| 2 | Ramp + 40 | 5 | 17 | 100 |
| 3 | Ramp + 35 | 5 | 17 | 100 |
| 4 | Ramp + 25 | 5 | 17 | 100 |
| 5 | Ramp + 20 | 5 | 17 | 100 |
| 6 | Ramp + 15 | 5 | 17 | 1 |

A summary an embodiment of a protocol for surface modifying capillaries is provided.

For PEG-silane modifications, the following steps were typically followed:
Step 1. Place capillaries in a conical tube suitable for the number of capillaries to modify. For 10-20 capillaries, use a 15 ml conical tube. For 30-50 capillaries, use a 50 ml conical tube.
Step 2. Clean and activate capillaries by immersion in 1 M HNO3 for 30 min, fill conical tube to the brim with HNO3. Note, this is a strong acid solution and highly corrosive. Take appropriate precautions when handling this solution and in subsequent wash steps.
Step 3. Wash away excess acid by filling conical tube with nanopure water then decant the liquid and repeat with 100% ethanol.
Step 4. Dry and store cleaned capillaries in a vacuum or lyophilizer.
Step 5. Submerge capillaries in a 2% silane solution in dry acetonitrile (v/v), for a 50 ml conical tube use 10-15 ml silane solution, allow the reaction to proceed on a benchtop tube rotator for 12 h.
Step 6. Decant silane solution and refill to the brim with pure acetonitrile to remove excess silane on the capillary surface. Rotate on a benchtop tube rotator for 1 h.
Step 7. Decant acetonitrile and replace with acetone. Rotate on a benchtop tube rotator for 1 h.
Step 8. Decant acetone and replace with water. Rotate on a benchtop tube rotator for 30 min.
Step 9. Decant water and replace with ethanol. Rotate on a benchtop tube rotator for 30 min.
Step 10. Decant ethanol, dry, and store surface-modified capillaries in vacuum.
Step 11. To avoid reaction of PEG with water vapor in the air, store in a vacuum or desiccator until pulled, and then return pulled needles to vacuum or desiccator until used.
(For PFDCS-silane modifications: Replace acetonitrile with toluene and reduce reaction time from 12 h to 6 h).

An embodiment of a protocol for ESI needle fabrication and characterization is provided.

2 micrometer electrospray needles were fabricated from borosilicate capillaries with filament (O.D. 1.2 mm, I.D. 0.58 mm, 1B120F-4, World Precision Instruments, Sarasota, FL) with a Flaming/Brown micropipette puller (P-97/P-1000, Sutter Instruments, Novato, CA) with the parameters shown in Table 2. The resulting needle orifices were manually inspected under a microscope to be approximately 2 micrometers.

0.1 micrometer electrospray emitters were fabricated from borosilicate glass with filament (O.D. 1 mm, I.D. 0.58 mm, BF100-58-15, Sutter Instruments, Novato, CA) with the following parameters: HEAT =Ramp, FIL =4, VEL =25, DEL =225, PUL =150 on a P-2000 micropipette puller. The resulting needle openings had diameters of approximately 100 nm. The size of the nano-emitter was estimated by the current measurement. Briefly, the needle was backfilled with 1xPBS and immersed in an identical bath solution. An Ag/AgCl wire electrode was placed inside the needle and another Ag/AgCl bath electrode was placed in the bath solution. At a potential of 100 mV, the current measured between the two electrodes was 0.9-1.1 nA.

Native MS of BSA, Lysozyme, and Ubiquitin.

Mass spectra were collected with a Q-Exactive HF quadrupole Orbitrap mass spectrometer equipped with ultrahigh mass range (UHMR) modifications (Thermo Fisher Scientific, Bremen). BSA and lysozyme were diluted to 500 nM prior to MS analysis. Five replicate measurements were collected with the control and chemically modified needles, alternating between each during MS analysis. Mass spectra were collected for 3 min. MS parameters of note include a trapping gas setting of 3 and a capillary temperature of 200° C. The high-collisional dissociation (HCD) cell and in-source trapping (IST) voltages were set to 0 V. The source fragmentation was set to 30 V for BSA and 0 V for lysozyme and ubiquitin. Detector optimization and transfer optics were set to low m/z, and the spray voltage was set to 1.1 kV. The resolution was set to 15000 for BSA and 60000 for lysozyme and ubiquitin. Positive ionization mode was used for all MS experiments.

For BSA, lysozyme, and ubiquitin, the signal intensity was calculated by summing the 3 min data set in Thermo QualBrowser and measuring the intensity of the most abundant charge state, which was +8 for lysozyme, +5 charge state for ubiquitin, and +17 or +16 for BSA. Error bars indicate the standard deviation for control and surface-modified needles (n=5 for each).

CD-MS of AAV Capsids.

Single-ion CD-MS was performed on the same UHMR Orbitrap mass spectrometer used for native MS analysis. Specifically, the signal intensity of single ions was used to determine the charge. As previously described, the S/N ratio was calibrated against known charges and used this calibration to determine the mass and charge of single ions (see Kostelic 2021). AAV capsids were analyzed similarly to what has been previously described, but the spray voltage was set to 1.1 kV for better resolution of AAV capsids and less background noise. It was found that increasing the capillary temperature to 350° C. and lowering the HCD voltage to 100 V reduced adduction and gave more accurate masses for empty AAV2 capsids. CD-MS spectra were acquired for 5 min, which were used to calculate the total number of single ions acquired for control and surface-modified needles. To reduce experimental variation, control and surface-modified needles were prepared on the same day and analyzed alternating between the two.

UniDecCD was used to process and count the number of single ions for AAV2. Parameters for processing and deconvolving AAV capsid spectra have been previously described (Kostelic 2021). Ions were counted and binned within an m/z window of 20000-35000 and a charge window of 100-200.

Flow Rate Determination.

Flow rates of PFDCS-coated, PEG-coated, and control nano ESI needles were determined by weighing the buffer solution consumed during the spraying process. Needles were backfilled to approximately 95% capacity with 0.2 M ammonium acetate buffer. The weights of the filled needles with an inserted silver wire electrode were recorded on a semimicrobalance (Quintix 125D-IS, Sartorius AG, Göttingen, Germany). The needles were then connected to an ESI power supply (HP020RZZ616B, Applied Kilovolts Ltd., West Sussex, UK) and mounted 5-6 mm away from a grounded metal plate serving as a counter electrode. A spray voltage of 1.2 kV was applied, and the sprays were allowed to proceed for 1 h with no external pumping or application of back pressure. The weights of the needles were measured again after the 1 h spraying period. The density of the buffer was used to determine the actual flow rate of each type of needle.

To determine if the surface modification improved sensitivity, BSA and lysozyme were first used as simple standards because they are known to nonspecifically adsorb to glass surfaces. With the PEG-modified needles, a higher signal intensity for BSA and lysozyme was observed compared with uncoated controls.

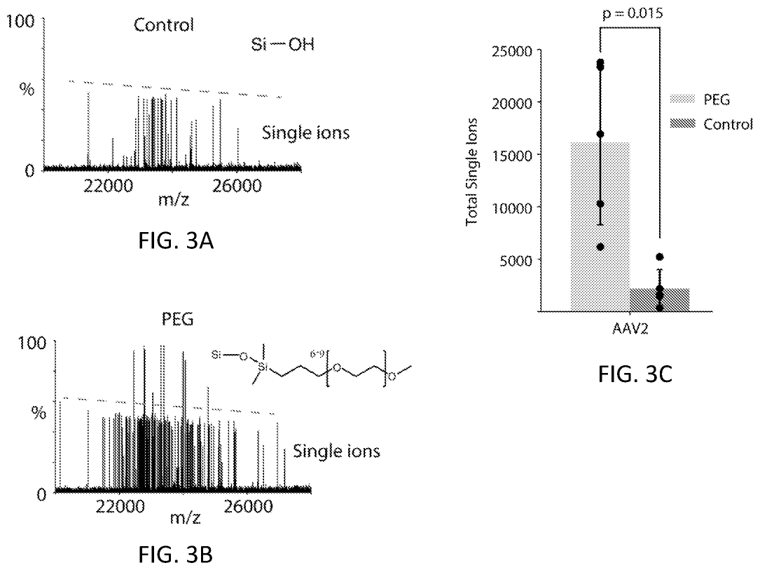

FIGS. 3A and 3B show raw mass spectra of BSA for uncoated control needles (FIG. 3A) and PEG-coated needles (FIG. 3B), showing an improvement in signal intensity. Signal intensity for the most abundant charge state for lysozyme (FIG. 3C) and BSA (FIG. 3D) with the PEG coated (light gray) and control (dark grey) nESI needles. The PEG coating increased the signal intensity and improved sensitivity for these standard proteins. Dots indicate the individual data points for each needle type with error bars indicating ±1 standard deviation (n=5).

Under proper storage conditions (see above), no residual free PEG or PEG associated with BSA or lysozyme was found. The improvements in signal intensity were roughly 2-fold for both. Minor adduction was observed for lysozyme after the buffer exchange, but the amounts were similar between the PEG-coated and control nESI needles. The similar adduction profile suggests that the droplets sizes may be similar between the two nESI needle types. Overall, the PEG coating significantly improved the native MS sensitivity for standard proteins with manually clipped nESI needles.

It was found that modified needles improved AAV CD-MS analysis. AAV capsids are currently being used as drug and gene therapy delivery systems and major strides have been made with CD-MS and native MS to characterize empty and filled AAVs. However, even single ion CD-MS methods can require high concentrations of AAV samples and long acquisition times to acquire the required number of ions (see Kostelic 2021). CD-MS of AAV capsids was obtained to see if the surface coating would increase the signal and lower acquisition times for dilute samples. It was found that PEG-modified needles yielded more than eight times higher total number of ions collected compared to the control needle at 2×10¹² capsids per milliliter.

FIGS. 3A-3C show CD-MS analysis of AAV2 capsids. Five averaged single scans for a replicate of (FIG. 3A) control and (FIG. 3B) PEG coated needles. The dashed line indicates the single ion level. FIG. 3C shows total number of single ions collected from a 5-minute CD-MS acquisition for empty AAV2 capsids. PEG coated needles (light gray) double the total amount of single ions compared to the control (dark gray). Dots indicate the individual data points for each needle type with error bars indicating #1 standard deviation (n=5).

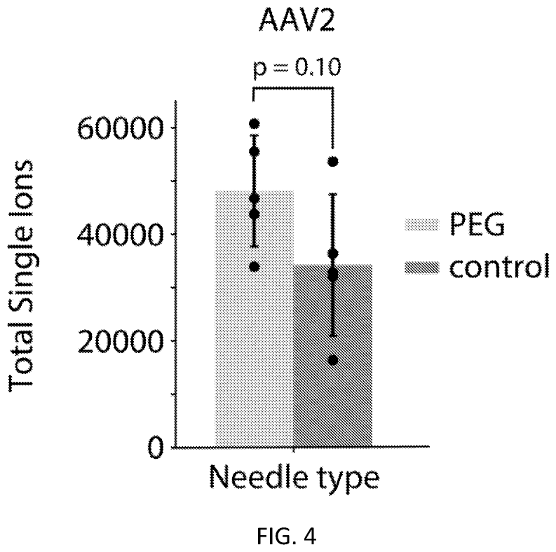

At higher concentrations, e.g., 1×10¹³ capsids per milliliter, there was a higher signal for the PEG-coated needles, but the statistical significance of the results was weak (p=0.1) (FIG. 4). Overall, the surface-modified needles provided higher ion currents for dilute AAV preparations. At the lower concentration, PEG-modified needles gave an average of 16.1±7.8×10³ single ions after a 5 min acquisition compared to 2.2±1.8×10³ ions for the control needles. In addition, the relative standard deviation observed for the total number of single of ions was 48% for the modified needles compared to 82% control needles, which was significantly lower according to the F-test, showing an improve reproducibility with the PEG-coated needles.

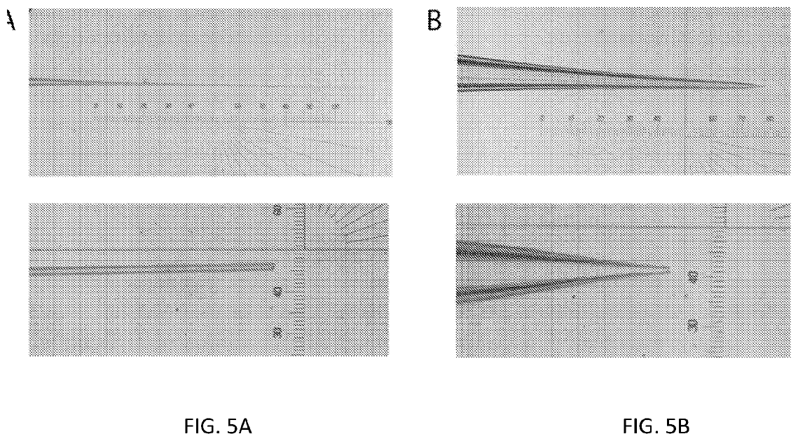

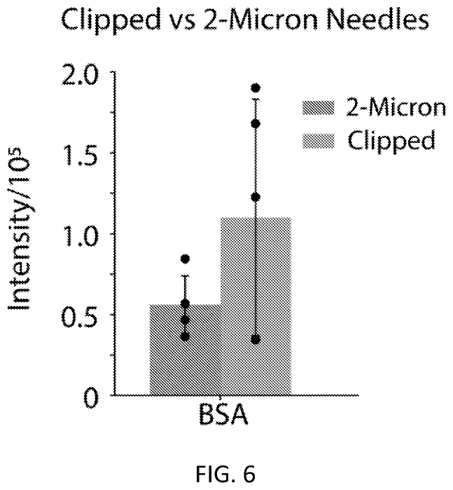

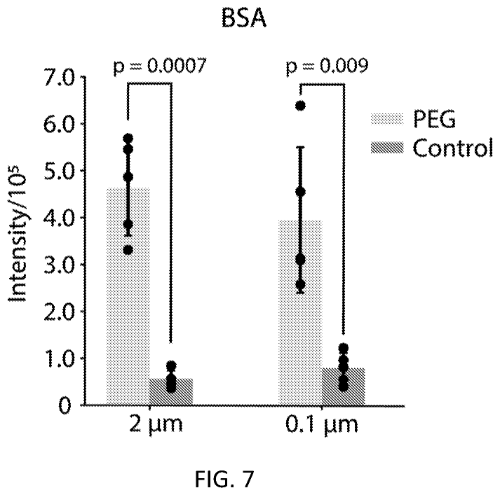

Improving reproducibility was observed with 2 micrometer nESI needles. Although the coated needles significantly improved the signal intensity at lower concentrations, both the control and modified needles had large needle-to-needle variation. Initially, it was hypothesized that the high standard deviations in signal intensity were due to differences in the tip diameter caused by the manual clipping of the electrospray needles. Manual clipping of the needle tips after pulling is common for native MS, giving a range of 1.5-4 micrometer tip diameters, as measured using a microscope (FIG. 5A). To minimize the variation of tip sizes and geometry, a 6-line program was developed (Table 2) for the pipet pullers to produce nESI needles that reproducibly had tip diameters of 2 micrometer and did not have to be manually clipped. The tip diameter was confirmed with a microscope (FIG. 5B). A tungsten wire was used in the back of the needle to apply the electrospray voltage for all samples in this study, so the needles were not coated with metal. The 2micrometer needles were tested with BSA, and it was found that the uncoated control single pull needle signal intensities were not statistically significant from control clipped needles (FIG. 6). However, the relative standard deviation for the single-pulled needles were 32%, which was lower than the clipped needles at 67%, confirmed with an F-test. PEG-coated 2 micrometer needles improved the signal intensity by almost 10-fold compared to uncoated 2 micrometer needles, and the data was more consistent run to run (FIG. 7).

Submicron emitters were explored to determine if the tip diameter would affect the improvement from the surface modification. It was found that the control 0.1 micrometer nESI needles had similar signal intensities for BSA compared to 2 micrometer needles. Like the 2 micrometer tips, the PEG modification increased the signal intensity for BSA 5-fold for the submicron tips (FIG. 7). Advantageously, surface coating was found to improve nESI sensitivity for needles of different geometries and thus can be implemented in needles of different diameters without manual clipping. It can be noted that pulling the nESI needles may either burn the coating off or dilute the coating through stretching at the tip of the needle. Attempts to prepare needles that were coated after pulling led to problems with the silane coating clogging the needle tip.

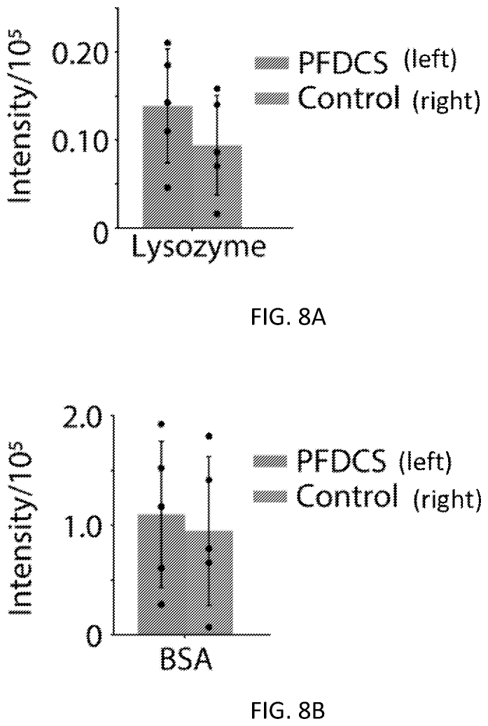

To test whether the improvement in sensitivity was due to reduced nonspecific adsorption to the glass, needles modified with PEG were compared to needles modified with PFDCS, a polyfluorinated molecule. PFDCS is known to provide an amphiphobic surface that repels both polar and nonpolar molecules, in contrast to the PEG coating that is hydrophilic. Although the surface chemistry is different, both reduce nonspecific adsorption. It was found that there were no statistically significant differences between the control and PFDCS modified needles (FIG. 8).

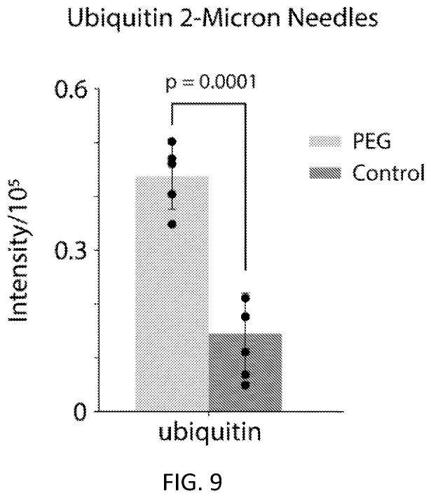

To further test whether the improvement was due to less nonspecific adsorption, the signal intensity of ubiquitin (which is known to not adsorb to glass nESI needles at neutral pH) was compared with 2 micrometer control and PEG-coated needles. A 3-fold improvement in the signal intensity was found with the PEG coating (FIG. 9).

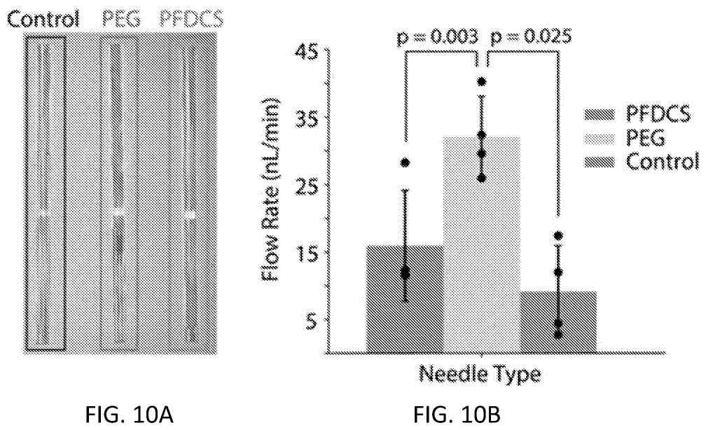

Capillary action of surface-modified needles was investigated. It was found that the bare borosilicate capillaries had the highest capillary action, PEG capillaries had an intermediate capillary action, and PFDCS capillaries had little to no capillary action (FIG. 10A). The flow rates were investigated for PFDCS modified, PEG-modified, and control nESI needles under static conditions with no fluid pumping or applied back pressure (FIG. 10B). It was found that PEG-modified nESI needles had the highest flow rate compared to PFDCS and control nESI needles, and the PFDCS modified and the control nESI needle flow rates were not statistically different.

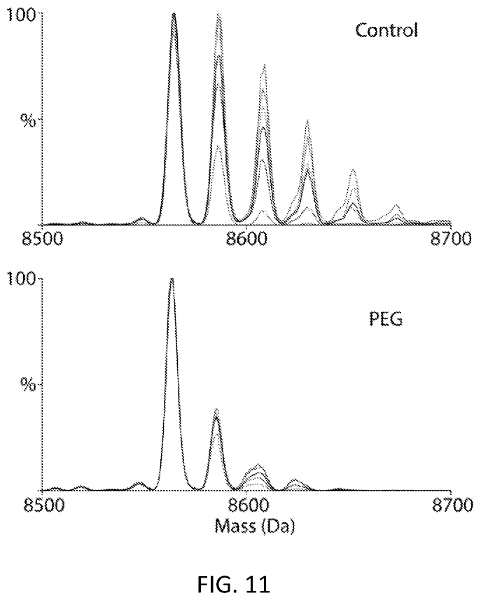

Interestingly, less sodium adduction of ubiquitin with the 2 micrometer PEG-coated needles was observed compared to the control needles (FIG. 11). Results from lysozyme on manually clipped needles, described above, showed similar levels of salt adduction between control and PEG needles, so the reduction of adduction may be protein or tip geometry dependent.

Surface modification procedure.

Two surface modification methods were developed for preparing electrospray needles: (a) liquid phase modification, and (b) gas phase modification.

For liquid-phase modification, borosilicate glass capillaries were cleaned by immersion in IM HNO₃ solution for 30 min prior to the silanization. Next, the capillaries were rinsed consecutively with nanopure water and ethanol and dried in a 170° C. oven overnight. The substrates were immediately transferred to a 2% (v/v) solution of silane modifiers (either of octyldimethylchlorosilane (ODCS) or (tridecafluoro-1,1,2,2-tetrahydrooctoyl)dimethyl-chlorosilane (PFDCS)) in toluene, and the reaction was allowed to proceed in an atmosphere-controlled environment for 6-8 h. Following the reaction, excess modifiers were washed off with successively rinsing with toluene, acetone, water, and ethanol, and the capillaries were dried in a 50° C. oven overnight and stored in a desiccator until pulled into electrospray needles using a P-1000 micropipette puller (Sutter Instruments).

For gas-phase modification, borosilicate glass capillaries were first pulled into electrospray needles as above, and then assembled in a silanization chamber, which was a straight-sided round jar having a volume of 118 mL. Next, 200 microliters of the silane modifier was added into the silanization chamber and the entire assembly was place on a hotplate to introduce silane vapor that modifies the glass surface. The gas-phase reaction was allowed to proceed for 5-10 min depending on the needle diameter, to allow for surface modification of the interior surface of the needle. The identical cleaning process described in the liquid-phase modification was used to clean the gas-phase surface modified needles.

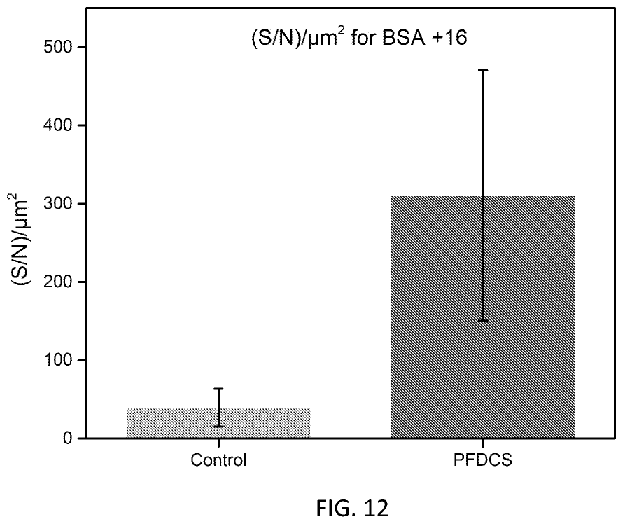

Some examples for demonstrating the use of these chemically modified electrospray needles included analyzing ubiquitin and bovine serum albumin (BSA) with electrospray ionization mass spectrometry (ESI-MS). Ubiquitin, Lysozyme and BSA are standard proteins that worked well as controls for these coated needles. With ubiquitin, the spray was more stable for longer acquisitions but had similar sensitivity. With BSA, a higher signal to noise (S/N) ratio was observed than with the control electrospray needles (i.e., not having the covalently bonded organic material), and electrospray needles according to the present invention allowed for higher sensitivity with BSA samples, as shown in FIG. 12.

Additional details regarding descriptions and examples encompassed by the invention can be found in Kostelic, M. M. et al., Journal of the American Society for Mass Spectrometry 2022, 33 (6), 1031-1037 “Surface Modified Nano-Electrospray Needles Improve Sensitivity for Native Mass Spectrometry”, which is incorporated herein by reference.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
K. Y. Law, J. Phys. Chem. Lett. 2014, 5, 686-688 “Definitions for Hydrophilicity, Hydrophobicity, and Superhydrophobicity”).
Wetterhall, Magnus & Nilsson, Stefan & Markides, Karin & Bergquist, Jonas. (2002). A Conductive Polymeric Material Used for Nanospray Needle and Low-Flow Sheathless Electrospray Ionization Applications. Analytical chemistry. 74. 239-45. 10.1021/ac010748f. https://www.researchgate.net/publication/11562619_A_Conductive_Polymeric_Material_Used_for_Nanospray_Needle_and_Low-Flow__Electrospray_Ionization_Applications
Gidi, Y. et al., ACS Appl. Mater. Interfaces 2018, 10, 46, 39505-39511 “Efficient One-Step PEG-Silane Passivation of Glass Surfaces for Single-Molecule Fluorescence Studies”.
Wang, X. et al., U.S. Published Patent Application No. 2018/0297029 (filed Apr. 16, 2018).
Kostelic 2021: Kostelic, M. M. et al., Analytical Chemistry 2021, 93 (44), 14722-14729 “Deconvolution of Charge Detection-Mass Spectrometry Data”.
Kostelic, M. M. et al., Analytical Chemistry 2022, 94 (34), 11723-11727 “Stability and Dissociation of Adeno-Associated Viral Capsids by Variable Temperature-Charge Detection-Mass Spectrometry”.
Kostelic, M. M. et al., Journal of the American Society for Mass Spectrometry 2022, 33 (6), 1031-1037 “Surface Modified Nano-Electrospray Needles Improve Sensitivity for Native Mass Spectrometry”.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

1. An electrospray needle comprising:
a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage;
wherein the first organic material is electrically non-conductive and non-ionizable;
wherein the fluid inlet has a first cross-sectional area, and the outlet orifice has a second cross-sectional area; and
wherein the first cross-sectional area is greater than the second cross-sectional area.

2. An electrospray needle comprising:
a hollow needle body comprising an outer surface, a fluid inlet, an outlet orifice, and an interior passage linking the fluid inlet and the outlet orifice in fluid communication, said interior passage comprising a first organic material covalently bonded to a surface of said interior passage;
wherein the first organic material is electrically non-conductive and non-ionizable;
wherein the fluid inlet has a first cross-sectional area, and the outlet orifice has a second cross-sectional area;
wherein the first cross-sectional area is greater than the second cross-sectional area; and
wherein at least a portion of the outer surface comprises a coating of an electrically conductive material.

3. The electrospray needle according to claim 1, wherein the hollow needle body comprises a material selected from the group consisting of borosilicate glass, glass-ceramic, aluminosilicate, quartz, fused silica, and combinations thereof.

4. The electrospray needle according to claim 1, wherein the hollow needle body comprises borosilicate glass.

5. The electrospray needle according to claim 2, wherein the electrically conductive material is an electrically conductive metal.

6. The electrospray needle according to claim 5, wherein the electrically conductive metal is selected from the group consisting of gold, palladium, platinum, and combinations thereof.

7. The electrospray needle according to claim 5, wherein the electrically conductive metal is gold.

8. The electrospray needle according to any one of claim 1, wherein the interior passage has a hydraulic diameter in a range of from about 0.1 micrometers to about 50 micrometers.

9. The electrospray needle according to claim 1, wherein the first organic material is selected from the group consisting of hydrocarbons, fluorocarbons, carbohydrates, and polyethylene glycols, and combinations thereof.

10. The electrospray needle according to claim 1, wherein the first organic material has a molecular weight of up to 10 kD.

11. The electrospray needle according to claim 1, wherein the organic material comprises a silane group.

12. The electrospray needle according to claim 1, wherein the organic material is covalently bonded to the interior passage surface by exposing the surface of the interior passage to a silylation reagent selected from the group consisting of ethyldimethylchlorosilane (EDCS), n-octyldimethylchlorosilane (ODCS), 3,3,3-trifluoropropyldimethylchlorosilane (FPDCS), trimethylchlorosilane TCS), (tridecafluoro-1,1,2,2-tetrahydrooctyl) trichlorosilane (PFTCS), (tridecafluoro-1,1,2,2-tetrahydrooctyl)dimethylchlorosilane (PFDCS). (heptadecafluoro-1,1,2,2-tetrahydrodecyl)dimethylchlorosilane (PFDDCS), 3-cyanopropyldimethylchlorosilane (CPDCS), and combinations thereof.

13. The electrospray needle according to claim 1, wherein the organic material is hydrophilic.

14. The electrospray needle according to claim 1, wherein the organic material is amphiphobic.

15. The electrospray needle according to claim 1, wherein the first organic material is resistant to water and organic solvents.

16. The electrospray needle according to claim 1, wherein the organic material has an electrical resistivity of greater than 10⁶ Ω at 25° C.

17. A mass spectrometry system, comprising:
a) an ion source comprising:
i) an electrospray needle comprising:
a hollow needle body comprising a fluid inlet, an outlet orifice, and an interior passage linking the fluid inlet and the outlet orifice in fluid communication, said interior passage comprising an interior passage surface having an organic material covalently bonded to said interior passage surface;
wherein the organic material is electrically non-conductive and non-ionizable;
wherein said fluid inlet has a first cross-sectional area and the outlet orifice has a second cross-sectional area; and
wherein the first cross-sectional area is greater than the second cross-sectional area;
ii) an electrode positioned with respect to the electrospray needle;
wherein, when a sample disposed in a carrier fluid is urged through the electrospray needle toward the electrode, a voltage can be applied to the electrode thereby forming ionized molecules of an analyte in the sample exiting the outlet orifice; and
b) a detector positioned with respect to the electrospray needle and the electrode to detect the ionized molecules.

18. A method of detecting an analyte using a mass spectrometry system according to claim 17, said method comprising steps of:
a) urging a sample of the analyte disposed in a carrier fluid through the electrospray needle of the mass spectrometry system according to claim 17 toward the electrode of the mass spectrometry system;
b) applying a voltage to the electrode, thereby forming ionized molecules of the analyte in the sample exiting the outlet orifice; and
c) detecting the ionized molecules of the analyte with the detector positioned with respect to the electrospray needle and the electrode to detect the ionized molecules.

19. The method of claim 18, wherein the analyte comprises a biomolecule.

20. A kit, comprising at least one coated electrospray needle according to claim 1 in a package, optionally including written instructions for use of the at least one electrospray needle.
